(19) United States
(12) Patent Application Publication
(10) Pub. No.: US 2026/0148476 A1
(43) Pub. Date: May 28, 2026

(54) Method and Apparatus for Improving the Efficiency of Linear Curve Geometry Traversal Using Linear-Swept Spheres

(71) Applicant: NVIDIA Corporation, Santa Clara, CA (US)

(72) Inventors: Joshua Noel, San Francisco, CA (US); David Hart, Salt Lake City, UT (US); John Burgess, Austin, TX (US); Eric Enderton, Berkeley, CA (US); Gregory Muthler, Chapel Hill, NC (US); Steven Parker, Draper, UT (US)

(21) Appl. No.: 18/957,854

(22) Filed: Nov. 24, 2024

(51) Int. Cl. G06T 15/06; G06T 15/00

(52) U.S. Cl. CPC G06T 15/06; G06T 15/005; G06T 2210/21

(57) ABSTRACT

Linear-Swept Sphere (LSS) primitives alongside hardware linear curve intersection testing and traversal logic allow traversal of curves directly within a hardware ray tracer. The introduction of the LSS primitive block, LSS primitive ranges, ray-LSS intersection testing, and LSS fetch removes the requirement that curve traversal utilize ray tracer item-ranges for traversal of curve primitives within a BVH and ray-curve intersection testing through software intersection shaders. Definition of an LSS primitive supports enablement of a single LSS endcap, query and return of the ray-LSS exit hit point, and degenerate-shell LSS intersection testing.

### CROSS-REFERENCE TO RELATED APPLICATIONS

None.

### FIELD

The technology herein relates to computer graphics, and more particularly to ray tracing and ray casting. Still more particularly, the technology herein relates to improving efficiency of processing linear curve geometry defined by swept spheres to enable real time or close to real time ray tracing, ray casting and other applications.

### BACKGROUND

Hair, fur, grass, and other strand-like objects frequently exist in both real-time graphics and professional visualization. A natural way to represent strand-like objects is with thick “spline” curves.

The term “spline” probably comes from the name of a tool used by drafts people long before the age of computers to manually draw a fair curve through a series of marked points. Such a tool comprised a long, flexible strip of wood or metal (the “spline”) and a series of metal weights. Because splines were often used to mark the curved hulls of watercraft for shaping and cutting, the metal weights were traditionally shaped as duck heads or whales. The user bent the flexible spline strip to align it with each of the marked points used to define the curve. The duck weights (now all in a row) held the flexible spline strip in its complex curved shape aligned with each “control point” while the draftsperson traced the spline strip's meandering curved path onto the drafting paper or wood surface.

Modernly, “spline” in computer graphics, solid modelling and other contexts has come to mean a piecewise polynomial (parametric) curve. Pierre Bézier pioneered the use of this type of spline at Renault for solid modelling of Peugeot car bodies, and Birkhoff and de Boor used such splines to help computer-design General Motors car bodies in the 1960's. See Birkhoff et al, Piecewise polynomial interpolation and approximation, in: H. L. Garabedian (ed.), Proc. General Motors Symposium of 1964, pp. 164-190. Elsevier, New York and Amsterdam, 1965.

FIGS. 1A, 2A, 2B, & 2C show splines as piecewise continuous parametric polynomial functions providing curves in 2D or 3D space. “Parametric” refers to parameterizing the polynomial function with control points that describe the curves' contours. These polynomial curve segments can be categorized by the “degree” of the polynomial (i.e., the highest power of the variable in the polynomial), the inputs to which are its control points. Each piece of a piecewise spline curve can be considered an independent curve segment.

Consider a control point data set of a set or cloud of individual points. As FIG. 1A shows, it is possible to use line segments to connect each pair of neighboring control points. The path formed by the collection of line segments is thus called “piecewise linear.” For example, we can find a first line that connects the first control (x1, y1) with the second control point (x2, y2), a second line that connects the second control point (x2, y2) with the third control point (x3, y3), and so on. But anyone who has bent a wire coat hanger knows that wire can be bent not just into piecewise linear segments, but instead into complex curved shapes such as also shown in FIG. 1A.

Higher order spline methods define curves by finding the equation of a polynomial of higher degree that connects the control points. FIG. 1A shows that a higher order (nonlinear) curve can also be used to define a common curved path through a set of control points. Some splines such as the one shown trace a path through the control points that approximates the control point positions. Much like the traditional physical flexible spline, other splines trace a curve that exactly intersects each (all) of the control points.

As FIG. 2B, 2C show, objects can be constructed in 2D or 3D space of such higher order (e.g., quadratic or cubic) curved splines. Linear curve segments such as in FIG. 2A are thus defined by two control points, quadratic curve segments such as FIG. 2B shows by three control points, cubic curve segments such as FIG. 2C shows by four control points, and so on. For a single curve segment, an increase in the number of control points implies an increase in the number of direction changes that the segment may contain.

It is possible to go to a higher degree than cubic but by connecting segments into a spline as shown, there is typically no need to go higher than cubic. To reduce representation complexity, it is possible to approximate a higher order curve with a lower order one. In particular, when a strand spline is built from one or more curve segments and the spline either approximates or interpolates the strand control points, splines built out of differing types of curve segments can be visually similar. Compare FIGS. 2A, 2B, 2C. It is easy to see visual differences between the linear splines of FIG. 2A and the quadratic splines of FIG. 2B, but visual differences between the quadratic splines of FIG. 2B and the cubic splines of FIB. 2C are more subtle.

When using “linear curves” (i.e., fitting a complex curve using piecewise linear segments) as shown in FIG. 2A to approximate higher order curves such as FIG. 2B, 2C where the joints between the linear segments can have sharp angles between segments, sampling is important to a smooth appearance. The spline can be sampled at needed intervals to introduce extra control points, and thus approximate the desired curve as closely as desired. See Nakamaru et al, Distance Aware Ray Tracing for Curves, ACM SIGGRAPH 2012 Posters; Woop et al, Exploiting Local Orientation Similarity for Efficient Ray Traversal of Hair and Fur, High Performance Graphics. 41-49 (2014). The “linear curve” splines shown in FIGS. 3A, 3B, 3C, 3D approximating a cubic segment (curve) are each constructed from piecewise linear segments. One can see that using more samples per cubic segment produces a progressively smoother appearance. Even though the FIG. 3D spline is constructed from 8 linear segments instead of being a continuous curve, it is difficult to distinguish it from the FIG. 2C spline constructed from the actual cubic curve.

In computer graphics, splines such as those discussed above can be used to construct and model 2D and 3D hair-like objects with open ends (see FIG. 1B), tubular worm-like objects with closed ends (see FIG. 1C) and many more. See e.g., Catmull et al, “A class of local interpolating splines” in Barnhill, et al (eds.). Computer Aided Geometric Design pp. 317-326. (1974). doi:10.1016/B978-0-12-079050-0.50020-5; E. Catmull et al, “Recursively generated B-spline surfaces on arbitrary topological surfaces”, Computer-Aided Design 10(6):350 355 (November 1978); Bartels et al, “An Introduction to the Use of Splines in Computer Graphics”, SIGGRAPH 1985; Bartels et al, An Introduction to Splines for Use in Computer Graphics and Geometric Modeling (Morgan Kaufmann 1995); U.S. Pat. Nos. 8,570,322; 7,009,608; U.S. Ser. No. 11/983,815.

Ray Tracing and Ray Casting with Splines

Once it became possible to represent CG virtual objects using splines, computer scientists began exploring how to use splines in ray tracing. See e.g., Kajiya, “Techniques for Ray Tracing Procedurally Defined Objects” (SIGGRAPH 1983); Barth et al, Efficient ray tracing for Bezier and B-spline surfaces, Computers & Graphics Volume 17, Issue 4 July-August 1993, Pages 423-430 doi.org/10.1016/0097-8493(93)90031-4; Sweeney et al, Ray Tracing Free-Form B-Spline Surfaces, IEEE Computer Graphics and Applications, vol. 6, no. 2, pp. 41-49, February 1986, doi: 10.1109/MCG.1986.276691; Zhang et al, CUDA-Based Volume Ray-Casting Using Cubic B-spline, 2011 International Conference on Virtual Reality and Visualization, Beijing, China, 2011, pp. 84-88, doi: 10.1109/ICVRV.2011.10;

Ray tracing is a rendering technique that can realistically simulate the lighting of a scene and its objects by rendering physically accurate reflections, refractions, shadows, and indirect lighting. Ray tracing generates computer graphics images by tracing the path of light from the view camera (which determines your view into the scene), through the 2D viewing plane (pixel plane), out into the 3D scene, and back to the light sources. See FIG. 3E. As it traverses the scene, the light may reflect from one object to another (causing reflections), be blocked by objects (causing shadows), or pass through transparent or semi-transparent objects (causing refractions). All of these interactions are combined to produce the final color and illumination of a pixel that is then displayed on the screen. See e.g., developer.nvidia.com/discover/ray-tracing

The geometric objects used for ray tracing can be composed of various types of primitives which can include splines. See e.g., U.S. Pat. No. 8,212,816.

However, as further explained below, calculating intersection between a ray and a given spline curve segment can still be a computationally intensive process. As the number of control points decreases or increases, so does the cost of ray-curve intersection. For example, the problem of intersecting a ray with a thick cubic (e.g., Bezier) spline is equivalent to solving a polynomial of degree 10, and therefore no analytic solution exists. Meanwhile, quadratic curves are a degree 6 polynomial problem.

A significant challenge to real time or close to real time ray tracing or ray casting is that existing ray tracing hardware cannot solve such degree 10 or degree 6 polynomials but must instead delegate the task to software shaders. This generally means using iterative “solver” techniques that can be powerful when implemented in software but are typically impractical to implement in consumer hardware based implementations. See e.g., Reshetov, Exploiting Budan-Fourier and Vincent's Theorems for Ray Tracing 3D Bezier Curves Proceedings of HPG '17, Los Angeles, CA, USA, Jul. 28-30, 2017, DOI: 10.1145/3105762.3105783 (2017); Reshetov et al, Phantom Ray-Hair Intersector, Proceedings of the ACM on Computer Graphics and Interactive Techniques, Volume 1, Issue 2, Article No.: 34, Pages 1-22, doi.org/10.1145/3233307 (2018); Reshetov et al, “Modeling Hair Strands with Roving Capsules” Article No.: 62, Pages 1-9 (SIGGRAPH 2024), doi.org/10.1145/3641519.3657450; www.shadertoy.com/view/4ffXWs; Daviet, Interactive Hair Simulation on the GPU Using ADMM (NVIDIA 2023) Special Interest Group on Computer Graphics and Interactive Techniques Conference Proceedings (SIGGRAPH '23 Conference Proceedings), Aug. 6-10, 2023, Los Angeles, CA, USA. ACM, New York, NY, USA, doi.org/10.1145/3588432.3591551. These speed challenges have caused developers of real time applications to simplify their models—reducing flexibility and photorealism.

In contrast, linear curves are a degree 2 problem; a piecewise linear representation (i.e., where the skeleton of the curve is linear) provides a quadratic surface description that has a single step analytic solution for ray-surface intersection testing. The associated numerics of a degree 2 problem are far easier to analyze and provide guarantees for as compared to cubic or quadratic splines/curves. Spline sampling and linear curve fitting as described above in ray tracing allows use of a simpler curve representation that is faster to intersect test than primitives defining higher order curves using polynomial equations. Further, as rays will typically intersect only one or a few segments of the spline's curve segments, the computation cost of intersection testing the full curve often scales sub-linearly with the number of segments. This means adding more segments via sampling improves performance—typically at the cost of using extra memory to represent the increased number of piecewise linear segments. Altogether, linear curve splines can produce images of sufficient visual quality by sampling any higher-order curve representation into enough linear curve segments.

### TTU Item Range Traversal

Typical real time ray tracers accelerate traversal of an acceleration data structure (AS) representing a bounding volume hierarchy (BVH) using a hardware circuitry based unit such as for example an NVIDIA Tree Traversal Unit (TTU). The TTU is a hardware unit which accelerates traversal of rays through a bounded volume hierarchy (BVH) and intersection testing geometry at the leaves (leaf nodes) of the BVH. For more information concerning the NVIDIA TTU in particular and ray tracing in general including real time ray tracing, see for example US 20140028687; U.S. Pat. No. 7,548,238; U.S. Ser. No. 10/580,196; U.S. Ser. No. 10/740,952; U.S. Ser. No. 10/810,785; U.S. Ser. No. 10/867,429; U.S. Ser. No. 11/157,414; US 20240095995; U.S. Ser. No. 11/508,112; U.S. Ser. No. 11/450,057; U.S. Ser. No. 11/380,041; U.S. Ser. No. 11/373,358; U.S. Ser. No. 11/302,056; U.S. Ser. No. 11/295,508; US 20140375659; US 20150042652; U.S. Ser. No. 10/269,166; U.S. Ser. No. 10/388,059; US20170206231; U.S. Pat. No. 9,171,394; US20180373809; F. Petrie et al, “Real Time Ray Tracing of Analytic and Implicit Surfaces,” 2020 35th International Conference on Image and Vision Computing New Zealand (IVCNZ), Wellington, New Zealand, 2020, pp. 1-6, doi: 10.1109/IVCNZ51579.2020.9290653; Stamminger et al. (2001). Interactive Sampling and Rendering for Complex and Procedural Geometry. In: Gortler, S. J., Myszkowski, K. (eds) Rendering Techniques 2001. EGSR 2001. Eurographics. Springer, Vienna. https://doi.org/10.1007/978-3-7091-6242-2_14; Ranta et al, (2006). GPU Objects. In: Kalra, P. K., Peleg, S. (eds) Computer Vision, Graphics and Image Processing. Lecture Notes in Computer Science, vol 4338. Springer, Berlin, Heidelberg. https://doi.org/10.1007/11949619_32; Kenwright, Real Time Ray Tracing with Vulkan (2024); Ray Tracing Gems: High-Quality and Real-Time Rendering with DXR and Other APIs (NVIDIA 2019); Tomas Akenine-Möller et al, Real-Time Rendering, Fourth Edition 4th Edition (CRC Press 2018).

While the TTU can efficiently perform real time ray tracing in hardware, past TTU hardware implementations have generally not been able to handle splines of any kind due to their complexity. The leaves of a BVH may be primitive ranges which are intersection tested within the TTU, or item-ranges (also known as procedural geometry) which are intersection-tested in a software routine(s) outside the TTU. When an item-range leaf is hit by a ray and an external software routine is used as the intersector, the TTU terminates traversal for that ray and returns the item-range to a user-specified Intersection Shader (IS) through the driver (RTCore). The software based IS then performs the intersection test on a processor outside of the TTU and passes the result to RTCore to have the TTU continue traversal if necessary. All this takes time.

### Example: OptiX Software Curve Intersectors

An example of a software shader which supports ray tracing intersection testing of spline curves is NVIDIA OptiX Curves [raytracing-docs.nvidia.com/optix8/guide/index.html #curves #curves-and-spheres]; Parker et al, “OptiX: a general purpose ray tracing engine”, ACM Transactions on Graphics (TOG), Volume 29, Issue 4 Article No.: 66, Pages 1-13 (2010), doi.org/10.1145/1778765.1778803; Ray Tracing Gems II: “Next Generation Real-Time Rendering with DXR, Vulkan, and OptiX” (NVIDIA 2021).

NVIDIA's OptiX Curves 7.4 (November 2021) supports intersection of multiple curve definitions including support for linear curves. See e.g., Kanell, “Latest NVIDIA OptiX Renders Ray Tracing Faster Than Ever Before” (NVIDIA Nov. 8, 2021); see also Nemire, “New NVIDIA OptiX Enhancements That Improve Your Ray Tracing Applications” (NVIDIA Apr. 12, 2021).

OptiX release 7.4 linear curves have spherical end caps, with spherical “elbows” for smooth joints between segments. As noted above, by default the ends of cubic and quadratic splines are open and do not have end caps. Flat end caps for cubic and quadratic splines can be enabled by setting OptixBuildInputCurveArray::endcapFlags and OptixBuiltinISOptions::curveEndcapFlags to OPTIX_CURVE_ENDCAP_ON. See e.g., raytracing-docs.nvidia.com/optix8/guide/index.htm.

While the OptiX linear curve representation is significantly faster to intersection test than higher order curves, such software-based execution flow carries significant performance penalties in comparison to other primitive type range traversal natively supported by modern TTU hardware for multiple reasons. Firstly, fixed-function hardware intersection testing is generally significantly faster than an equivalent software implementation. Secondly, the TTU performs the intersection tests for a primitive range without the significant overhead of redirecting to an IS executed outside the TTU. In addition to IS execution cost, there is also a memory overhead to mapping BVH item-range leaves to their corresponding primitive data used by the intersection shader.

For example, the following traversal flow is an example of the performance penalty of a software intersector. A range of software linear curves may be represented as an item-range within the BVH to take advantage of BVH traversal TTU hardware acceleration. On intersection of such an item-range, the software-based intersection testing of software linear curves involves terminating or suspending TTU hardware traversal for the ray, executing the OptiX linear curve intersection shader in software, and restarting TTU hardware traversal for the ray if required. This all takes time, which may make real time or close to real time rendering unrealizable or impose significant constraints on scene complexity (for example, modeling the 100,000 hairs on a typical human head becomes impractical).

In sum, there is a high computational cost associated with intersecting rays and such spline curves. This cost is high enough that direct curve representations are often considered inapplicable to real-time use altogether.

### Objects Based on Swept Spheres

Another way to model CG objects is by sweeping a shape through a volume. Swept spheres have for many years been used for ray tracing. See e.g., Van Wijk, Ray Tracing Objects Defined by Sweeping a Sphere, Computers & Graphics, Volume 9, Issue 3, 1985, Pages 283-290, ISSN 0097-8493, doi.org/10.1016/0097-8493(85)90055-X. Van Wijk describes a DEC PDP 11/44 Pascal software implementation using a parameterized swept sphere connected with piecewise polynomial functions (splines). Ray intersection procedures operate on the piecewise polynomial, so inputs are converted to a linear list of segments each defining a piece of the object. The sphere can be defined by its radius a and 3D coordinates (rx, ry, rz) of its center r. Such swept spheres can be used to model many useful tubular objects of various sorts (see e.g., FIGS. 7-12 of Van Wijk).

NVIDIA Optix 7.7 (2023) software also supports rendering spheres as a primitive (for example, as particles). See e.g., FIG. 4 and the function OptixBuildInputSphereArray at raytracing-docs.nvidia.com/optix7/api/struct_optix_build_input_sphere_array.html

Meanwhile, within NVIDIA OptiX Curves, a linear curve is defined by a single endcap enablement flag and two control points: the position and radii of two spherical endcaps which are joined by a midsection as FIG. 4 shows. The combination of this definition and the software intersection routine places restrictions on the visualization of the curve primitive. Specifically, the endcaps of the curve are either both enabled or both disabled, and if the endcap positions and radii form a shell, all intersection testing of the primitive results in a miss. Accordingly, there are some functional limitations when using OptiX curves.

### Tessellated Ribbons

A different way to implement strand-like objects is using tessellated ribbons. See e.g., Reshetov, “Ray/Ribbon Intersections”, Proc. ACM Comput. Graph. Interact. Tech., Vol. 5, No. 3, (July 2022). Many other techniques have also been proposed which have been widely used in the film industry where minimizing rendering time is not critical. See e.g., Ward et al, “A Survey on Hair Modeling: Styling, Simulation, and Rendering,” in IEEE Transactions on Visualization and Computer Graphics, vol. 13, no. 2, pp. 213-234, March-April 2007, doi: 10.1109/TVCG.2007.30. However, such techniques may often involve ray-facing and camera/viewpoint-facing reorientation computations as the scene and/or camera/viewpoint position changes which make real time graphics generation difficult using present technology.

### SUMMARY

There is thus a long felt but unsolved need for efficient techniques to render strand-like objects such as hair, fur and grass. For example, as real time graphics systems have approached and perhaps even in some cases surpassed photorealism, it would be highly desirable to be able to realistically model and image the 100,000 hairs on a typical human head in real time.

The technology herein addresses these and other problems including high-cost ray-curve traversal and intersection.

An example embodiment provides a hardware-based ray tracer comprising: a multi-pass ray-primitive intersector circuit configured to receive first data indicating a ray and second data representing a linear swept sphere primitive, the ray-primitive intersector circuit determining intersection between the ray and the linear swept sphere primitive, wherein the multi-pass ray-primitive intersector circuit includes a loopback connection that the multi-pass ray-primitive intersector circuit with a variable number of passes depending on at least one characteristic of the second data.

At least one characteristic comprises whether the second data represents a degenerate or a non-degenerate linear swept sphere primitive.

The multi-pass ray-primitive intersector circuit comprises an intersector pipeline and a distance calculator pipeline each comprising at least one hardware adder circuit, at least one hardware multiplier circuit and at least one hardware comparator circuit.

The linear swept sphere primitive includes first and second endcaps, and the second data includes a first field that enables the first endcap and a second field that enables the second endcap, wherein the first and second endcaps can be independently enabled and disabled.

The linear swept sphere primitive can selectively be opaque or transparent.

The linear swept sphere primitive includes first and second spheres each having a specifiable center point and a specifiable radius, and further includes a linear connector between the first and second spheres, wherein the linear connector intersects each of the first and second spheres tangentially to the respective sphere.

The multi-pass ray-primitive intersector circuit is configured to calculate and report a distance parameter u along the linear connector where the ray intersects the primitive.

The multi-pass ray-primitive intersector circuit is configured to determine whether the ray intersects the first sphere or the second sphere without intersecting the linear connector between the first sphere and the second sphere.

The multi-pass ray-primitive intersector circuit is configured to determine intersection between the ray and the linear swept sphere primitive without referring the intersection determining to any processor executing a software shader.

A further embodiment provides a non-transitory memory connected to a hardware-based ray tracer, the non-transitory memory storing acceleration data blocks comprising data representing linear swept sphere primitives, wherein the data includes mode indicators that indicate: Explicit Vertex Indexing wherein a VertexIDs array specifies explicit vertex indices for every primitive (i.v0, i.v1); Chains with Shared Implicit Indexing wherein Vertex indices are applied sequentially and an i.chainStart bit vector specifies which vertices are shared between neighboring primitives; Unconnected Unshared Implicit Indexing wherein two vertex indices are applied sequentially per primitive; and Spheres with Unshared Implicit Indexing wherein a single vertex index is applied sequentially per primitive, with both the v0 and v1 indices pointing to that same vertex.

A further embodiment provides a ray tracer intersector circuit comprising: an intersection pipelined circuit configured to receive linear swept sphere primitive data and ray original and direction data, and is further configured to test whether a conical surface represented by the linear swept sphere primitive data intersects a ray; and a distance pipelined circuit connected to the intersection pipelined circuit, the intersection pipelined circuit configured to output intersection coordinate values indicating where the ray intersects the conical surface, wherein the intersection pipelined circuit is further configured to test whether an interpolation of the conical surface exists at an instant of the ray.

A further embodiment provides an acceleration data structure builder comprising: at least one processor or processing circuit configured to execute instructions stored in non-transitory memory to perform operations comprising: providing to an output file, delta compressed vertices of spheres defining center points and radii of a multiplicity of linear swept sphere primitives; and specifying to the output file, an indexing mode from a set consisting of Explicit Vertex Indexing, Chains with Shared Implicit Indexing, Unconnected LSS: Unshared Implicit Indexing, and Spheres: with Unshared Implicit Indexing.

The acceleration data structure builder further specifies to the output file, whether the linear swept sphere primitives are to be interpolated to detect whether they exist at an instant of a ray.

The acceleration data structure builder further specifies to the output file, a number 1-N of primitives.

The acceleration data structure builder further specifies to the output file, whether the linear swept sphere primitives are transparent.

The acceleration data structure builder further specifies to the output file, an identifier for each primitive.

The acceleration data structure builder further specifies to the output file, a variable precision of vertex center points and a variable precision of the radii.

The acceleration data structure builder further specifies to the output file, an LSS header that specifies to hardware that the output file contains linear swept sphere primitives.

The acceleration data structure builder further specifies to the output file, whether the linear swept sphere primitives have constant alpha values across the output file.

A further embodiment provides a non-transitory memory coupled to a hardware decoder and intersector circuit, the non-transitory memory storing a data file comprising: delta compressed vertices of spheres defining center points and radii of a multiplicity of linear swept sphere primitives; an indexing mode indicator selected from a set consisting of Explicit Vertex Indexing, Chains with Shared Implicit Indexing, Unconnected LSS with Unshared Implicit Indexing, and Spheres with Unshared Implicit Indexing; an indicator of whether the linear swept sphere primitives are to be interpolated to detect whether they exist at an instant of a ray; a value indicating a number 1-N of primitives; an indicator indicating whether the primitives are transparent; an identifier for each primitive; a variable precision for vertex center points and a variable precision for radii; an LSS header that specifies to the hardware decoder that an output file contains linear swept sphere primitives; and an indicator of whether the linear swept sphere primitives have constant alpha values across the data file.

### BRIEF DESCRIPTION OF THE DRAWINGS

FIG. 1A shows a prior art thin 2D spline curve and control points.

FIG. 1B shows a prior art thick 2D spline curve and control points.

FIG. 1C shows a prior art thick 3D spline curve and control points.

FIGS. 2A, 2B and 2C show prior art multicurve strands defined by different degrees of spline curves.

FIGS. 3A, 3B, 3C, 3D show prior art strands define by different numbers of linear segments per cubic segment.

FIG. 3E shows basic ray tracing concepts.

FIG. 4 shows prior art OptiX linear curves.

FIG. 5 shows an example linear-swept sphere (LSS) definition.

FIG. 5A shows an example LSS primitive with a lefthand sphere having a larger radius than a righthand sphere.

FIG. 5B shows an example LSS primitive with a righthand sphere having a larger radius than a lefthand sphere.

FIG. 5C shows an example LSS primitive with a lefthand sphere having the same radius as a righthand sphere.

FIG. 5D shows a ray passing through an LSS primitive.

FIG. 5E shows an LSS primitive with a lefthand endcap enabled and a righthand endcap disabled.

FIG. 5F shows an LSS primitive with a lefthand endcap disabled and righthand endcap enabled.

FIG. 5G shows an LSS primitive with a lefthand endcap disabled and a righthand endcap also disabled.

FIG. 5H shows an LSS primitive degenerated to model a single sphere.

FIG. 6 shows example renders of objects modeled using OptiX linear curves and a chain of linear-swept spheres as disclosed herein.

FIG. 7 shows a sphere-degenerate LSS.

FIG. 8A shows a shell-degenerate LSS with two positive radii.

FIG. 8B shows a shell-degenerate LSS with one negative radius.

FIG. 9 shows example LSS entry and exit hit points.

FIG. 10 shows an interpolated negative radius LSS.

FIG. 11 shows an example LSS primitive data block definition.

FIG. 12 illustrates example LSS motion interpolation.

FIG. 13 shows LSS primitive block indexing mode examples.

FIG. 14 shows an example LSS primitive range stack entry.

FIG. 15 shows an example LSS primitive fetch stack entry.

FIG. 16 shows example LSS primitive range and primitive fetch stack initializers.

FIG. 17 shows an example ray hitting an LSS infinite cone and missing the LSS.

FIG. 18 shows an example TTU block diagram.

FIG. 19 shows an example RPT ray-LSS intersection test dataflow.

FIG. 20 shows an example ray-LSS RPT intersection pipeline circuit.

FIG. 21 shows an example RPT ray-LSS flowchart.

FIG. 22 shows an example HitType_Linear Swept Sphere hit return data block.

FIG. 23 shows example LSS fetch registers.

FIG. 24 shows an example LSS hit return.

FIG. 25 shows an example block diagram of a real time graphics system for ray tracing LSS primitives.

FIG. 26 shows an example ray tracing intersector process flow.

FIG. 27 shows an example high level TTU block diagram.

FIG. 28 shows an example flow of processing by TTU hardware circuitry.

### DETAILED DESCRIPTION OF NON-LIMITING EMBODIMENTS

### Linear-Swept Sphere (LSS)

To overcome such limitations as described above, this technology introduces among other things:
a hardware-supported linear curve primitive, the Linear-Swept Sphere (LSS);
hardware support for traversal of BVHs encoding ranges of LSS primitives; and
hardware support for ray-LSS intersection testing.

In combination, these enable high-performance traversal of BVHs containing linear curve geometry without reducing the visual fidelity of this geometry in comparison to existing software implementations.

In particular, Linear-Swept Sphere (LSS) primitives alongside hardware linear curve intersection testing and traversal logic allow traversal of curves directly within a hardware ray tracer accelerator. Specifically, the introduction of the LSS primitive block, LSS primitive ranges, ray-LSS intersection testing, and LSS fetch removes any requirement that curve traversal utilize ray tracer item-ranges for traversal of curve primitives within a BVH and ray-curve intersection testing through software intersection shaders. In addition, example definition of an LSS primitive supports features not currently present in prior approaches such as the OptiX linear curve definition. For example, one example LSS definition supports enablement of a single LSS endcap, query and return of the ray-LSS exit hit point, and degenerate-shell LSS intersection testing.

### Example Linear-Swept Sphere (LSS) Definition

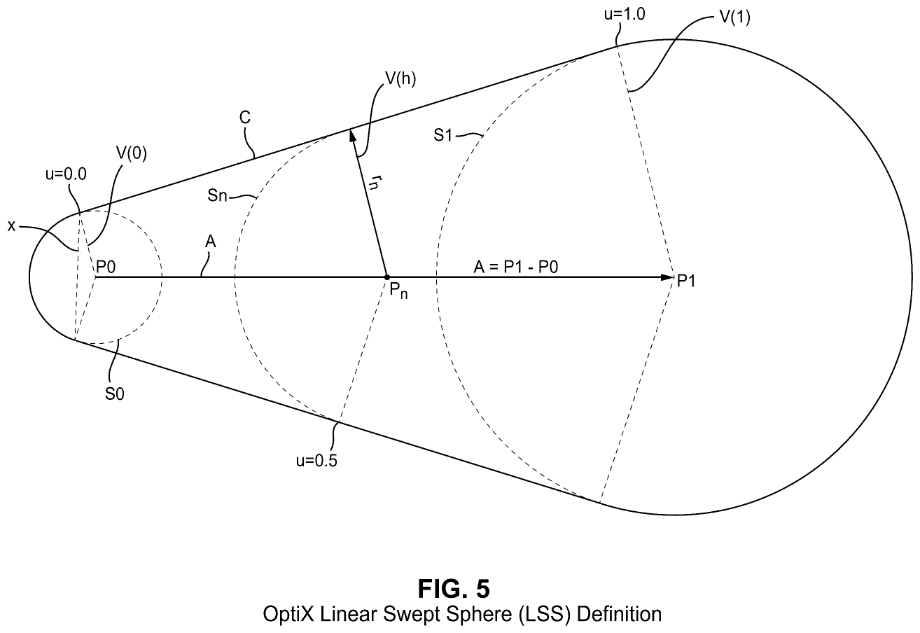

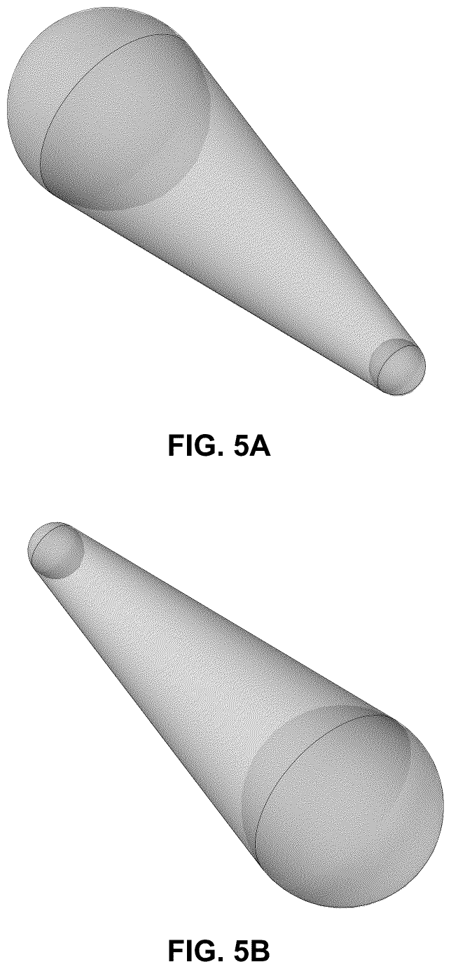

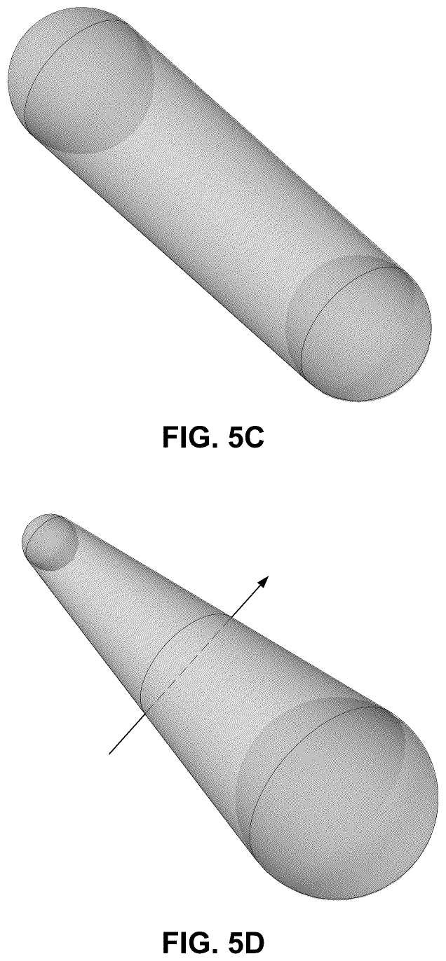

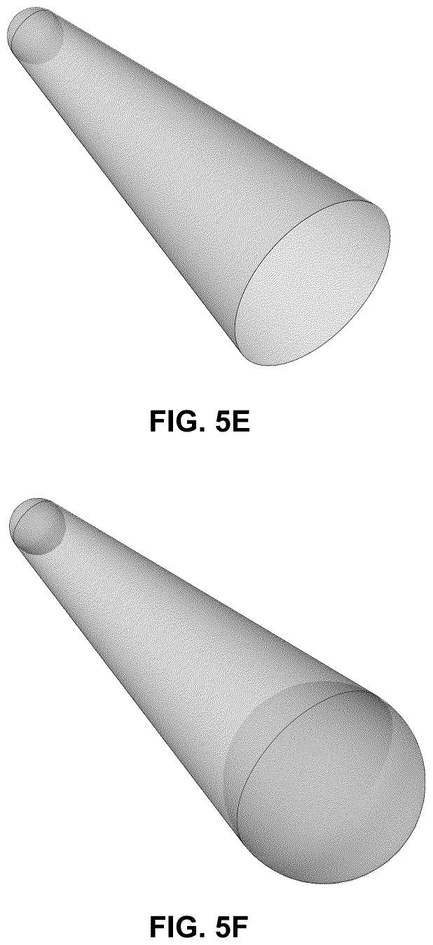

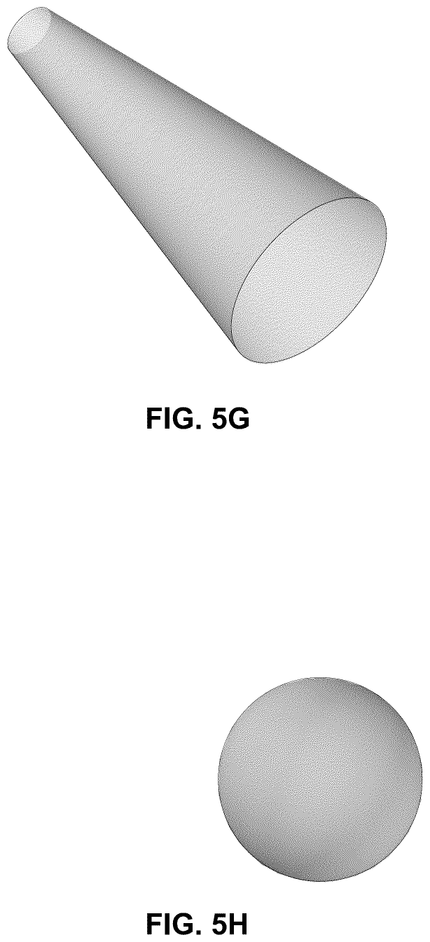

FIG. 5 shows an example definition of an LSS primitive which can be used to model cones, cones with rounded end caps, cylinders and spheres. Divergence can be reduced by representing and rendering each of these different object types using the same homogenous set of primitives.

The primitive comprises a first sphere S0, a second sphere S1, with a cone segment C in between. The cone C is tangent to each of the two spheres S0, S1 where the cone touches the spheres. By rough analogy, imagine dropping a marble into a conical ice cream cone and then placing a tennis ball on top of the cone. The marble and the tennis ball will each intersect the conical ice cream cone in a respective circle.

FIG. 5 shows the general case of two spheres S0, S1 of different radii. Either sphere can have the bigger radius. See FIG. 5A, 5B. The primitive supports two spheres of the same radii as well connected by a cylinder (see FIG. 5C), but in the general case the spheres do not have to have the same size, i.e., one sphere can be bigger than the other sphere.

FIG. 5 shows an axis A between the center point P0 of sphere S0 and the center point P1 of sphere S1. Because the spheres S0, S1 are of different sizes in the general case, the linear connector between them is conical rather than cylindrical. In particular, the cone C does not intersect the sphere at the great circle of the sphere defined at P1 and offset perpendicular to axis A, it instead intersects at a circle on the sphere's surface other than the great circle in order to be tangent to that spherical surface where it contacts the spherical surface. Accordingly, the line segment X shown perpendicular to A in the FIG. 5 2D diagram (which would in 3D define a plane) does not pass through the vertex P0.

Similarly, the vector V shown with length rₙ is not perpendicular to axis A in this example but instead is offset at an angle other than 90 degrees relative to axis A. This offset angle is constant all the way along the curve/cone (i.e., the angle vector V(0) makes with axis A is the same as the angle vector V(1) makes with axis A and is the same as angle V(n) makes with axis A).

When the intersector determines the ray has hit the outside surface of the object (see FIG. 5D), the intersector returns the u value that corresponds to the position P along the axis A corresponding to where the ray intersects the conical outer surface. This u value distance is called the parameter of the linear curve. There is an angle of “lean” (one way or the other) in the general case where the two spheres S0, S1 have different sizes. For example, if a ray were to intersect the object shown at the end point of radial line segment rₙ, the intersector would return u=0.5 indicating the midpoint between the two tangent locations (u=0, u=1) where the conical surface touches the two spheres, along the outside conical surface of the object. In this case, the start of radial line segment rₙ from the central axis A of the cone between center points P0, P1 to the outer surface of the code is the midpoint Pₙ along axis A.

In example embodiments, a user should understand that the intersector's u report indicating the point on the surface of the object between the two tangent circles was intersected, does not necessarily project perpendicularly onto the central axis A, but instead projects at an angle determined by the differential in size between the two spheres S0, S1. For example, when the intersector reports that the ray intersects the object surface at the point at which vector V(n)=0.5, the user can if needed use that reported value to calculate the corresponding value Pₙ along central axis A by taking halfway between P0 and P1.

For larger visualization applications involving e.g., 2D texture mapping, one could include a second parameter in addition to u that parameterizes the intersection point about the circumference of the primitive, to provide two texture mapping coordinates, e.g., in order to wrap a texture around the primitive's outer surface. Such second coordinate adds complexity and is not typically needed for shaded and/or 1D textured (color ramp) objects such as hair or fur strands or blades of grass, or for larger visualization where shading and/or 1D texturing is an acceptable surface treatment.

FIG. 5 further shows that rₙ is the radius of a swept sphere Sn interpolated between sphere S0 and sphere S1. There is a family of interpolated swept spheres defined between sphere S0 and sphere S1. The center of each of these swept spheres is on central axis A. Each swept sphere has a size determined by where the center point of the swept sphere Sn lies on axis A. The LSS primitive is convex and encloses a volume. As shown in FIGS. 5D & 9, any ray intersecting the LSS primitive will have exactly one entry point and exactly one exit point. In the general case assuming the ray intersects the conic surface between the two spheres S0, S1, the ray's entry point is associated with one interpolated swept sphere, and the ray's exit point is associated with a different interpolated swept sphere. There are thus (in the general case) two virtual spheres associated with any given ray: one virtual sphere the ray touches on the way into the primitive, and another virtual sphere the ray touches on the way out of the primitive. The ray could pass through any number of virtual spheres within the primitive as it travels between its entry point and exit point, but example embodiments of the intersector do not test for those internal intersections because they are unimportant for visualizations associated with ray tracing. Accordingly, the hardware intersector determines intersections of rays with the primitive's outer surface. In one embodiment, the hardware can report a ray's intersection entrance point and the ray's intersection exit point. Exit point reporting may be useful in some cases for example for simulating refraction through a transparent or semi-transparent primitive.

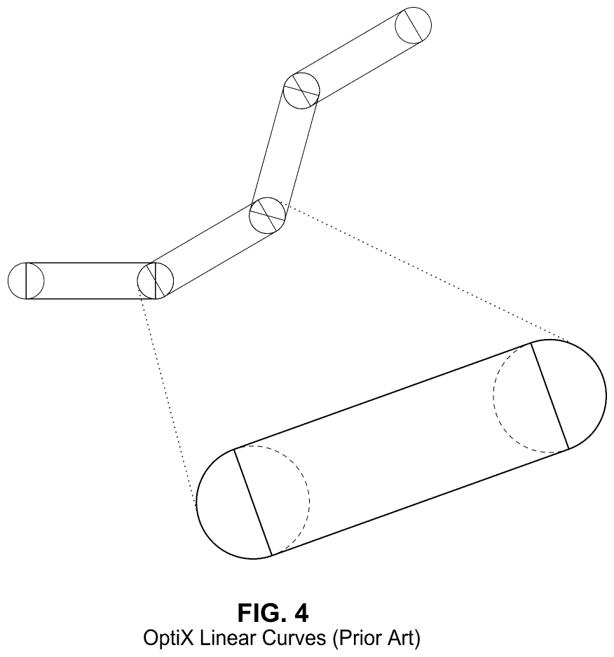

Using LSS primitives as piecewise linear connections (splines) to model a higher order curve (see FIG. 4) provides a spherical joint at every linear segment connection, which eliminates discontinuities. It also enables a static AS representation that does not need to be updated with movement of the virtual camera (viewpoint). It also provides a smooth profile, i.e., the object presents a “round normal” that sweeps the angles from a perpendicular facing the virtual camera to a perpendicular away from the virtual camera. This simplifies shading the object as the virtual camera changes position relative to the object (see e.g., U.S. Ser. No. 10/068,366) as compared to shading flat objects such as ribbon primitives.

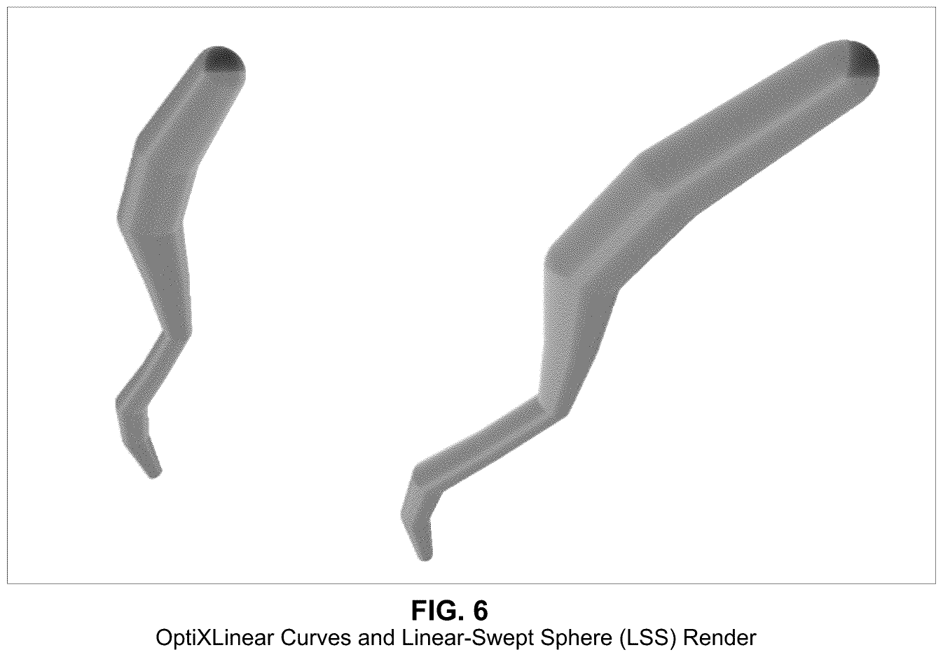

In example embodiments herein, the geometry of a Linear-Swept Sphere (LSS) is defined such that rendering time aside, they can be visually identical from a rendering perspective to NVIDIA OptiX Linear Curves with some additional configuration options. See FIG. 6 left-hand rendering from Optix linear curves and the FIG. 6 right-hand rendering from an LSS implementation.

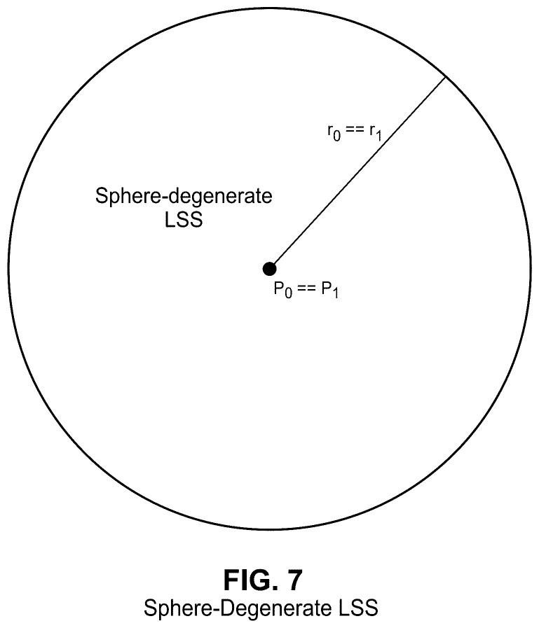

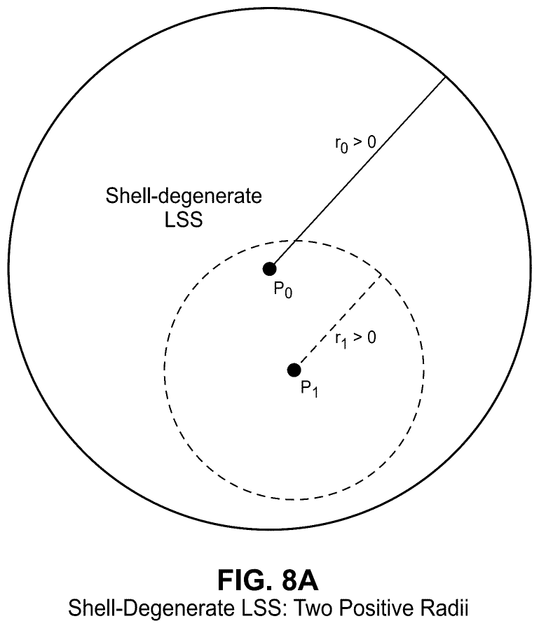

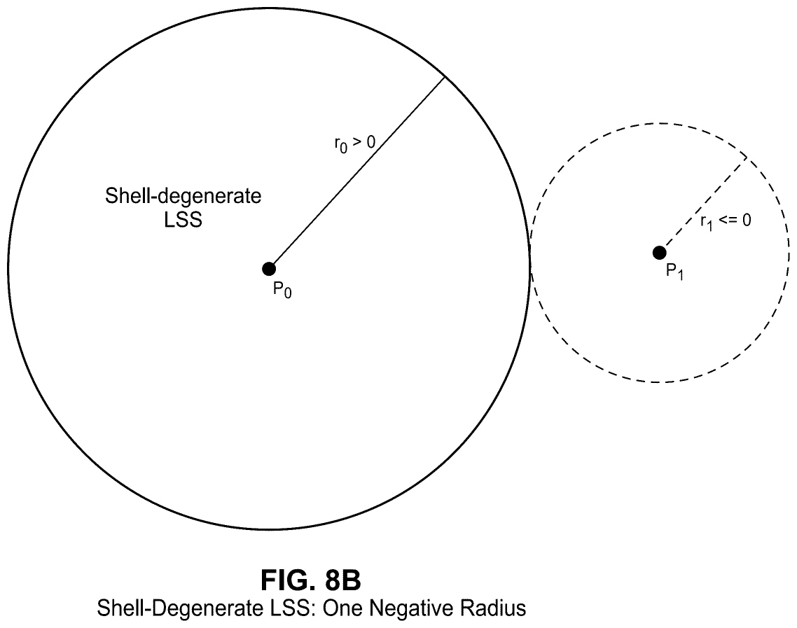

With respect to the additional configuration options of LSS, intersection of each endcap of an LSS can be individually enabled/disabled (see FIG. 5E, 5F, 5G), and the LSS can take the form of a shell-degenerate LSS (see FIGS. 8A, 8B). In example embodiments, there are at least two degenerate forms of LSS:
“sphere-degenerate” (FIG. 7) where spherical endcaps have equal position and radii therefore the LSS represents a single sphere (FIG. 5H, 5H) (that is—the sphere is not actually swept through space since the two spherical endcaps are exactly coincident), and
“shell-degenerate” (FIG. 8A, 8B) where endcap positions or radii are not equal but the LSS has nevertheless been reduced to a single intersectable endcap (FIGS. 8A, 8B). As shown in these FIGS. 8A, 8B, there are at least two kinds of shell-degenerate LSSes:
(a) each spherical endcap has a positive radius (FIG. 8A) and one sphere is inside the other; or
(b) one spherical endcap has a positive radius and the other has a negative radius (FIG. 8B). In this case, the endcap with the negative radius is treated as a shell once that endcap touches the other endcap with a positive radius. As explained below, the endcap with the negative radius does not need to be inside the endcap with a positive radius so long as the two spheres are touching one another.

### Reducing or Minimizing Size of the LSS Primitive Representation

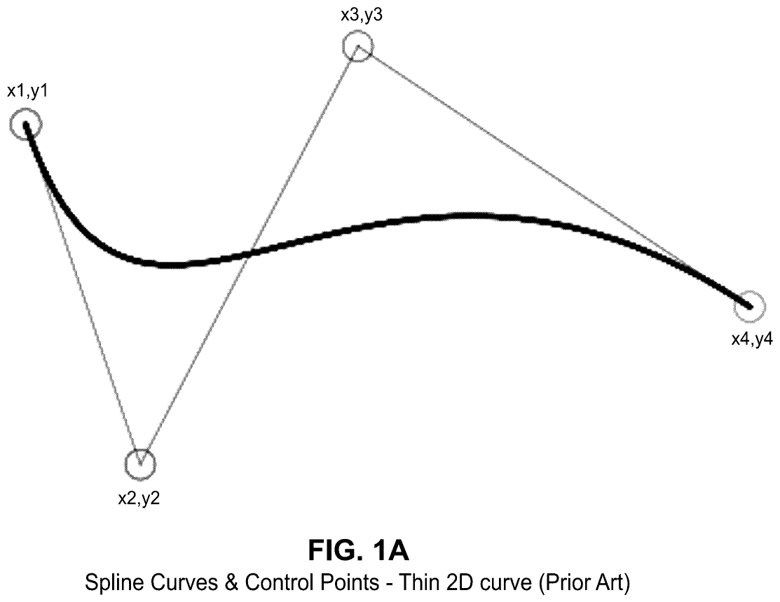

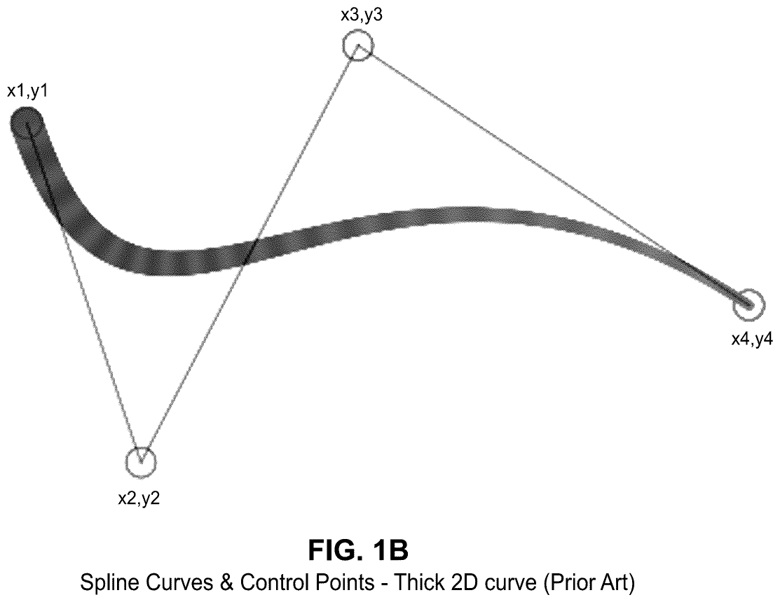

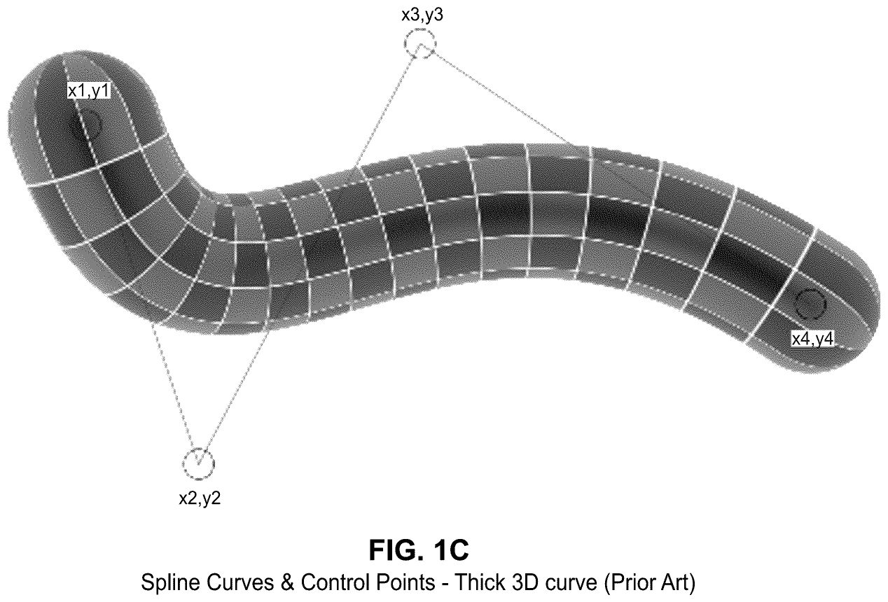

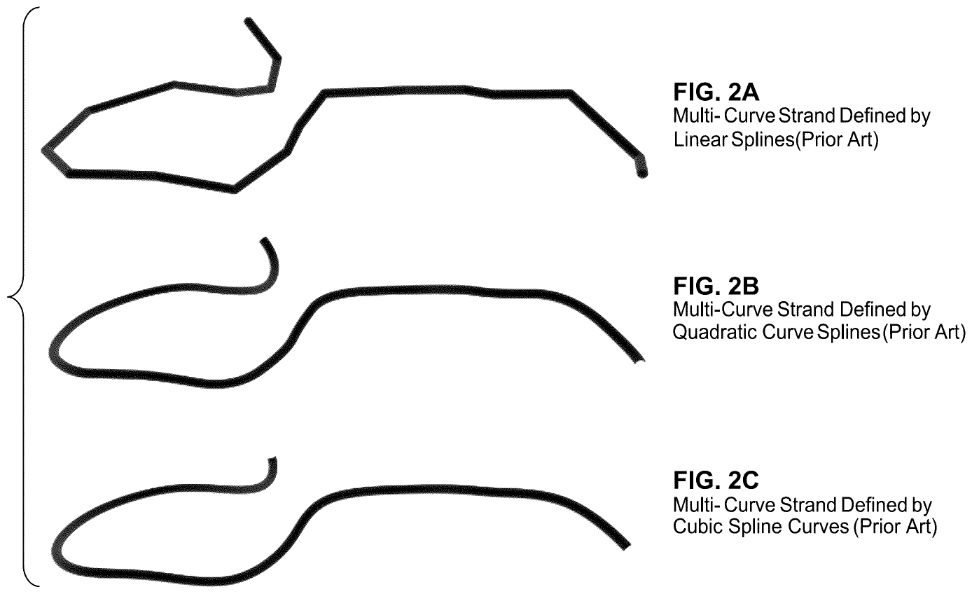

One challenge associated with using LSS primitives is reducing the size of the data representation. While it is possible to use an LSS primitive individually (e.g., to model a single sphere), LSSes will typically be used together as part of a collection of many LSSes (for example, to model many hairs on a human head, many blades of grass in a field, etc.). Furthermore, LSSes will also be used as linear curve splines to define curved objects such as shown in FIG. 1B, 1C. This often means chaining several or multiple LSSes together (see FIG. 6) for each object (so that for example, each hair strand might comprise a curved portion starting from where the hair grows from the hair follicle connected to a straight (or straighter) portion (or further curved portions depending on the hair style) where the hair falls. See e.g., Bao et al, “An Image-Based Hair Modeling and Dynamic Simulation Method,” in IEEE Access, vol. 5, pp. 12533-12544, 2017, doi: 10.1109/ACCESS.2017.2720465, disclosing use of many Bezier splines to model short, curled and wavy hair styles. A grass blade similarly may comprise a straight portion where it exits the ground connected to a curved portion that may change its curve depending on how the wind is blowing. Sampling rates as discussed above also come into play in terms of determining how many linear curve splines are used to model each individual strand-like object.

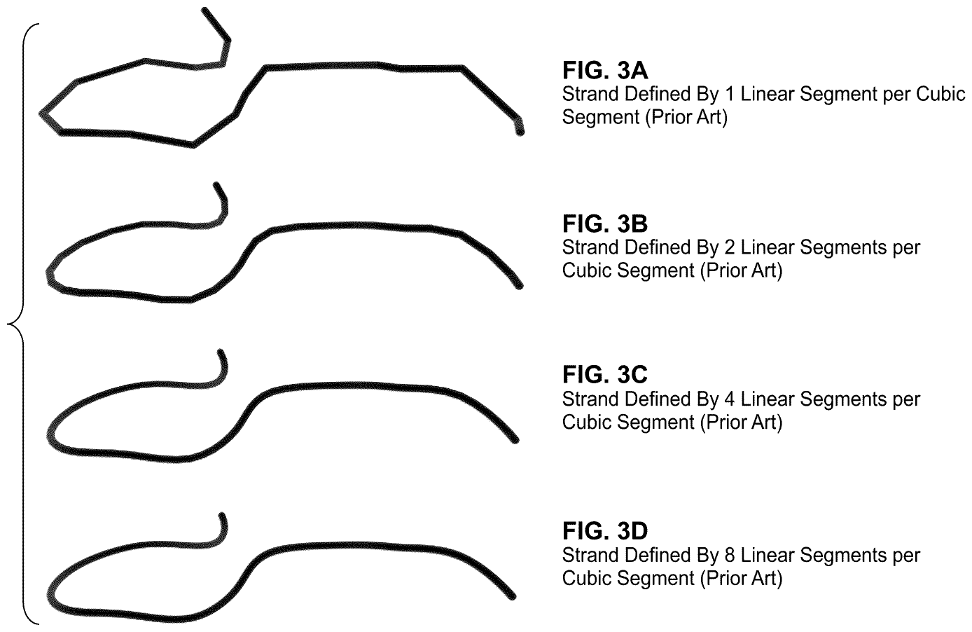

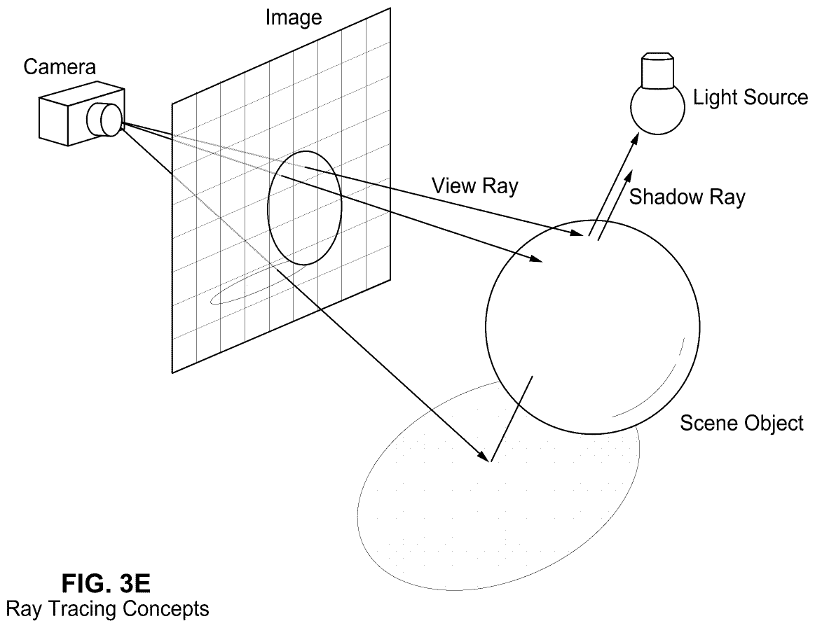

In particular, as shown in FIG. 1A, a cubic spline representation comprises four control points per cubic segment. Such a representation can be very memory efficient but as discussed above in detail is impractical to implement in modern consumer hardware circuits. FIG. 3D shows that by sampling a cubic curve finely enough, it is possible to represent what appears to be a smooth curve out of piecewise linear segments (sufficient samples prevent the viewer from seeing any hard angles between the linear joints). Increasing the number of samples increases both complexity of sampling and memory costs associated with storing the increased number of samples. The linear LSS primitive trades these factors away to achieve faster rendering speed and supports moving the camera (viewpoint) without any need to update the primitive. But the example embodiment LSS primitive data representation discussed herein includes features allowing it to be very compact. Compactness reduces not only memory latency involved in fetching the data representation from memory but also reduces the time required to read data representations fetched from main memory into the TTU hardware and store them in the TTU internal storage for controlling operations by the TTU's hardware circuits.

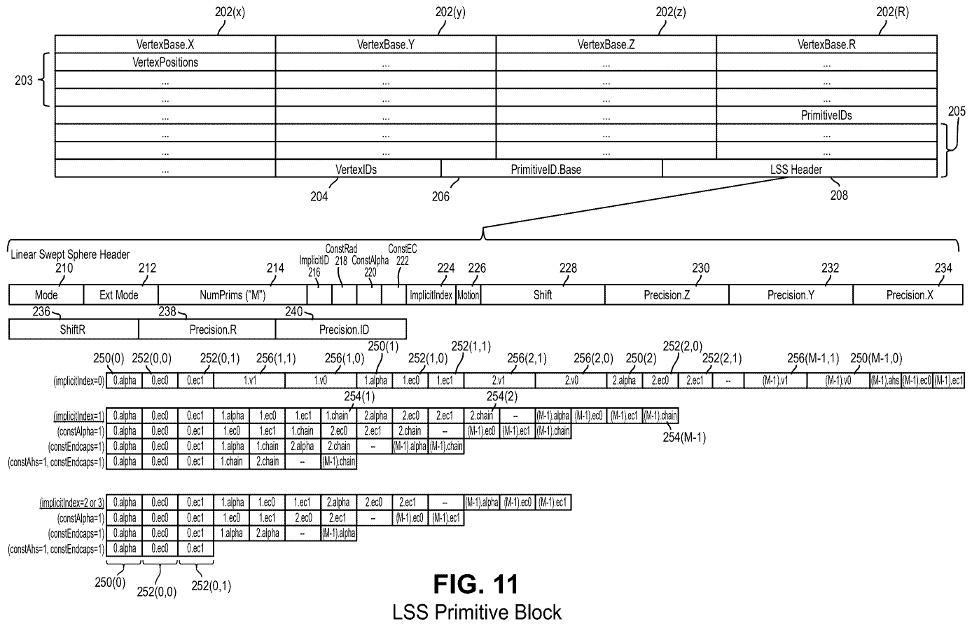

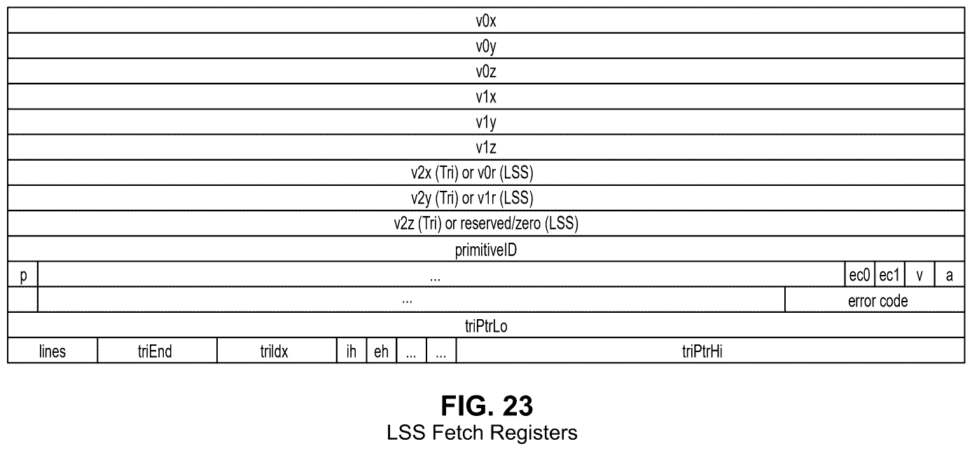

In one embodiment, the geometry and metadata of all LSS in a BVH is compressed into primitive blocks for memory efficiency (see discussion below in connection with FIG. 11). In addition to ray-LSS intersection, TTU support for LSS includes the ability to independently fetch compressed LSS from these blocks independent of full BVH traversal (see discussion below in connection with FIG. 23).

### LSS BVH Traversal

Traversal by a TTU of an acceleration structure (AS) such as a bounding volume hierarchy (BVH) and the creation, storage and use of such BVH is described for example in U.S. Ser. No. 10/580,196. Briefly, the acceleration data structure most commonly used by modern ray tracers is a bounding volume hierarchy (BVH) comprising nested axis-aligned bounding boxes (AABBs). The leaf nodes of the BVH contain the primitives to be tested for intersection. The BVH is most often represented by a graph or tree structure data representation.

Given a BVH, ray tracing amounts to a tree search where each node in the tree visited by the ray has a bounding volume for each descendent branch or leaf, and the ray only visits the descendent branches or leaves whose corresponding bound volume it intersects. In this way, only a small number of primitives must be explicitly tested for intersection—namely those that reside in leaf nodes intersected by the ray.

In example embodiments, ranges of LSS are encoded as leaf nodes within the BVH. When the TTU intersects such a leaf node during traversal, or the TTU receives a request to test a specific range, the associated primitive blocks within that range are fetched from memory and hardware ray-LSS intersection tests are executed by the TTU hardware circuits for all LSS in the range entirely within the TTU in one embodiment.

### Hardware Ray-LSS Intersection

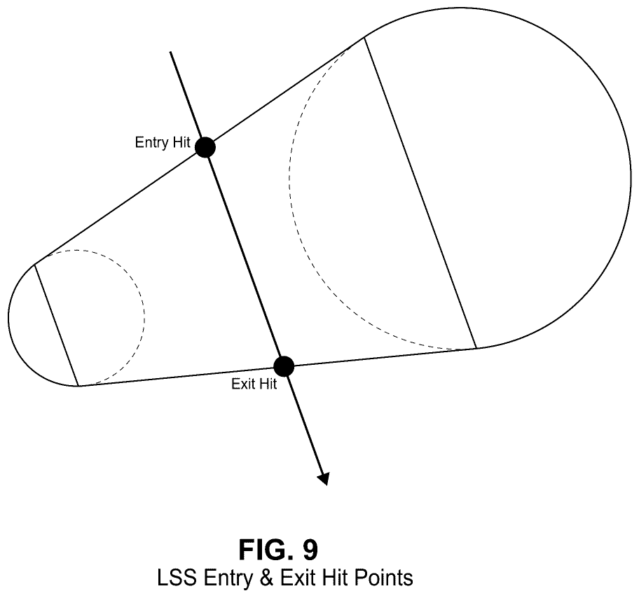

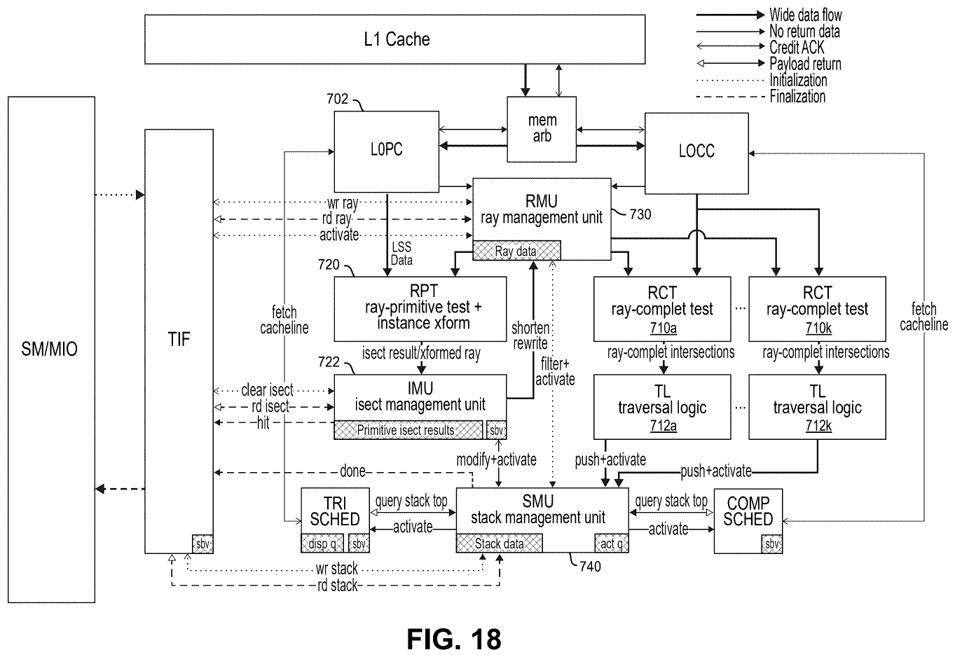

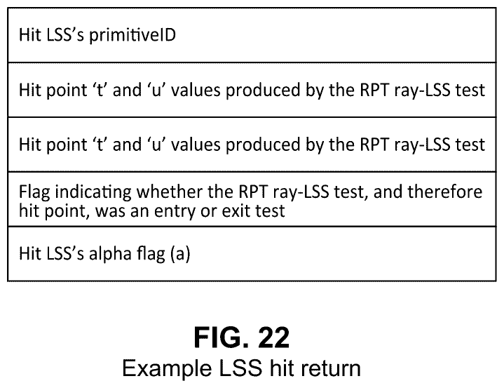

In one embodiment, hardware support for ray-LSS intersection testing is implemented within the TTU (see FIG. 18 block diagram) as multi-pass execution over a pipeline of fixed-function math units. As input, the intersection test uses the LSS primitive geometry information and a flag denoting which of the ray's entry hit point or exit hit point should be returned (see FIG. 9). As output, the pipeline (as FIG. 22 shows) produces a hit or miss result. For a hit, ‘t’ and ‘u’ parameters (spatial coordinates) are generated. The ‘t’ value represents the hit point's distance along the ray, and the ‘u’ value represents the hit point's location along the LSS axis (see FIG. 5 discussion above). These two values, along with the ray's origin and direction, encode the spatial cartesian coordinates of the hit point.

### Additional Linear-Swept Sphere Definition Details

In example embodiments, TTU's Ray Primitive Test (RPT) sub-unit (see FIG. 18; this unit previously referred to in some contexts as a “Ray Triangle Test” or “RTT” unit) is augmented with additional hardware circuits to support Linear-Swept Sphere (LSS) intersection testing. In one embodiment, RPT receives the following ray and LSS curve parameters (see FIG. 5 definition/parameters) from the Ray Management Unit (RMU) and the Level 0 Primitive Cache (LOPC), respectively (note that the LOPC has previously been referred to as a Level 0 Triangle Cache or LOTC):
rayOrig—input ray origin
rayDir—input ray direction
P0—LSS endcap 0 center point (3D coordinates)
r0—LSS endcap 0 radius
P1—LSS endcap 1 center point (3D coordinates)
r1—LSS endcap 1 radius

FIG. 5 shows a geometric representation of these curve parameters. Note that as discussed above, these parameters may themselves be parameterized by 0.0≤u≤1.0 defining the normalized distance between the LSS endcap 0 center point and the LSS endcap 1 center point.

In one embodiment, RPT returns a hit/no-hit result after the intersection test. RPT also computes and returns the following parameters for intersection hits:
t—ray parameter for the hit point
u—curve parameter for the hit point, split into 3 ranges:
0.0—endcap 0 hit
(0, 1)—midsection hit
1.0—endcap 1 hit.

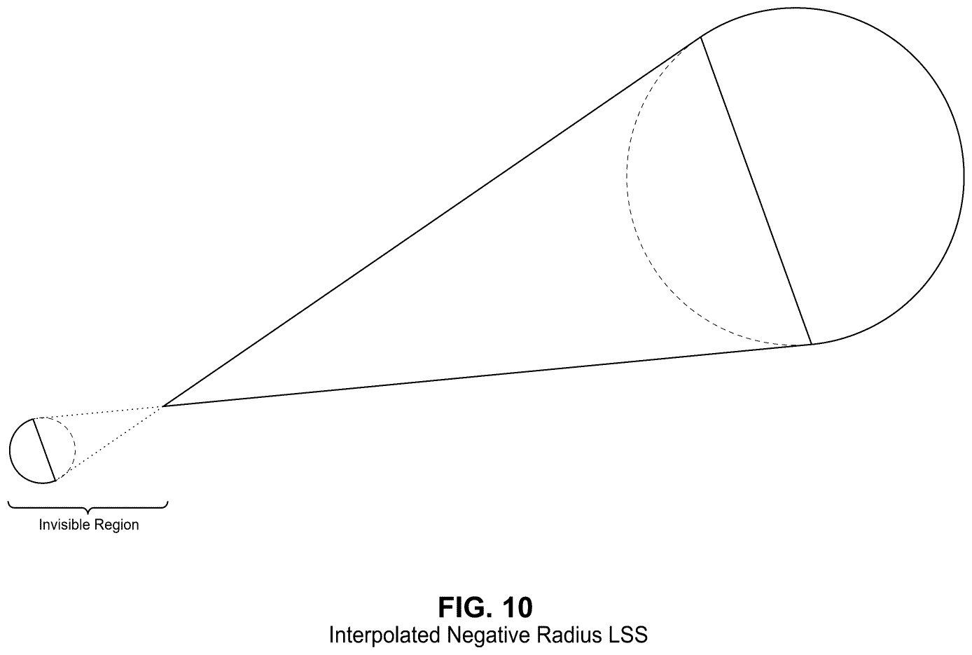

As noted above in connection with degenerate LSS types, one of the LSS's radii in example embodiments may be negative (see FIG. 8B). When this occurs, neither the negative endcap nor the portion of the midsection with a negative interpolated radius are intersectable (FIG. 10—“invisible region”). As discussed below, RPT is structured to recognize this and take it into account.

The TTU can perform all of these operations in its own internal circuitry without the need or requirement to call external software such as shader or solver software for handling. The RPT thus generally does not need to suspend any operation waiting for an external shader or solver software routine to start, run and finish in order to determine intersection. Instead, the RPT is able to detect ray-LSS primitive intersection internally and act accordingly (e.g., by reporting a hit, continuing to traverse the BVH, cull missed portions of the BVH, etc.) As described below, there may be some special cases (e.g., relating to transparency) where it is useful in some embodiments to call a software shader to help test for intersection, but most ray-LSS intersection testing does not require this.

It will be appreciated that in example embodiments, the above-described intersection testing can be conditioned on a bounding volume test determining the ray intersects an AABB bounding volume that bounds the LSS. In other words, the BVH typically enables the TTU to use such bounding volume tests to cull portions of the BVH (including LSS leaf nodes) so more intensive ray-geometry intersection testing does not need to be performed. See for example U.S. Ser. No. 10/580,196.

### LSS Primitive Representation

Example embodiments generate (build) and provide an acceleration data structure (AS) that compactly represents LSS primitives. A compact representation is helpful to provide the TTU (and its RPT) with information it needs in a timely matter to perform the ray-LSS intersection testing. The AS build can be performed by a developer in advance, or by a CPU and/or a GPU during real time graphics generation, or both. Typically, instructions stored in non-transitory memory will be executed or performed by a computing component such as a CPU, GPU, etc. that creates or converts suitable object models into the form shown in FIGS. 5 & 13.

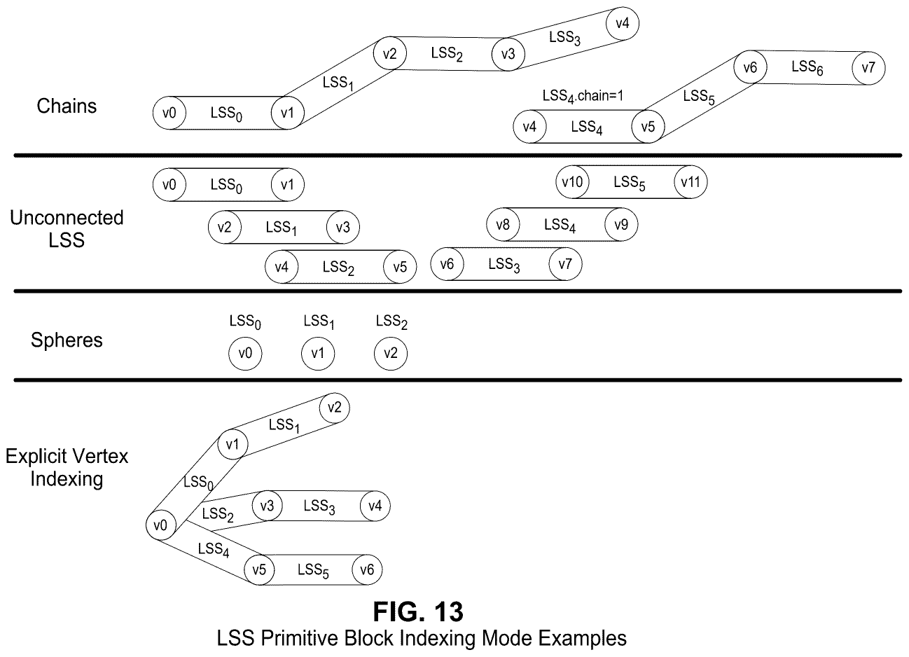

As FIG. 13 shows, any given object can be modeled with one or more LSS chains of LSSes interconnected as linear splines, by one or a plurality of unconnected LSS objects, by one or a plurality of individual spheres modeled by LSSes, by explicit vertex indexing of LSS chains, etc. Generally speaking, not every arbitrary object will efficiently be represented by LSSes (many objects will be represented more efficiently by triangles, polygons, other types of procedural geometry modeling, etc.). But LSSes (including degenerates thereof such as individual spheres) can be helpful and useful in efficiently representing a wide variety of strand-like objects, molecule models, etc.

In example embodiments, the BVH defines LSS primitives in the same range as other commonly used primitives such as triangles. Accordingly, the overall structure and ranges of the BVH can remain the same when defining the new LSS primitive. In example embodiments, it is only when blocks within the BVH range reach the RPT inside the TTU do LSS primitives need to be differentiated from triangles and thus details of the new LSS primitives come into play. Accordingly, implementation impact within the TTU is relatively limited. Other hardware implementations can of course have different tradeoffs.

As discussed above, every LSS is defined by two vertices and two radii. The data block shown in FIG. 11 provides a mechanism for the RPT to decode first and second vertices and a radius for each of a plurality or multiplicity of LSSes along with certain metadata such as motion, transparency, etc. The data block shown in FIG. 11 is constructed by a builder that constructed the AS including leaf nodes representing LSS primitives. Each and every field the FIG. 11 data structure shows is specified by such a builder, before the data structure is provided to the TTU for processing.

The RPT can detect whether the block encodes LSS primitives as opposed to triangles or some other primitives by determining whether an LSS Header 208 is present. If an LSS Header 208 is present, the RPT processes the data block as encoding LSS primitives. If the LSS Header 208 is not present, the RPT processes the data block as encoding triangles or some other non-LSS primitive(s).

In one example embodiment, each LSS primitive data block shown schematically in FIG. 11 defines a plurality or multiplicity of LSS primitives. The block is composed of delta-compressed vertices 202 defining bounding volumes, primitive IDs 206, vertex indices (per-vertex data) 204, and an LSS header 208. The block stores a base vertex (X, Y, Z) and a base radius (R) that applies in common across all LSSes in the block (the block provides deltas for each LSS vertex and radius to define the LSS vertex positions and radii relative to these base values).

### Example Delta Compression

### Relevant Block Fields:

VertexBase.X/Y/Z/R 202
Precision.X/Y/Z/R 230, 232, 234, 238 (precision for each delta)
Header.Shift(for X,Y,Z)/ShiftR 228, 236
“Vertex Positions Array” 203 (contains vertex and radius deltas for each LSS relative to the base values)
PrimitiveID.Base 206
Precision.ID 240
“Primitive IDs Array”

All vertices in the block are defined as a vertex position and radius. Positions and radii are delta-compressed with a base value provided by the VertexBase.X/Y/Z/R values 202 and deltas provided in an indexed “Vertex Positions Array” 230. The RPT indexes into the Vertex Positions Array 230 to look up the two vertex deltas and radius deltas of each LSS. Some number of override bits from the “Vertex Positions Array” 203. The number of bits overridden is defined by the Precision.X/Y/Z/R fields 230-234, 238 in the block header. To reduce representation size, some example applications represent the primitive with limited precision that can cause fuzzy edges when enlarged rendering of the primitive on a display occurs. In example embodiments, the Precision fields are variable/dynamic to allow the user to change the tradeoff between storage space and clarity, depending on how the objects will be rendered in the scene. Precision here doesn't really mean accuracy in the usual sense; it just means how many bits were used to encode all the non-base vertices. The BVH builder software is where the ‘precision’ & deltas are computed, and they can vary depending on how many bits in the primitive block's x/y/z/r channels match. A reason for storing a variable precision is that an example embodiment TTU does not encode or detect duplicate vertex bits (e.g., base vertex 0 X value vs vertex 1 X value). The RPT unit in the TTU just needs to know what the encoded ‘precision’ is in order to decode.

### Example Decoding

Below is an example formula to decode the X-component of a delta-compressed vertex. The Y, Z, and R components use the same formula with their corresponding inputs.

$$DeltaMask \cdot X = ( ( 1 << Precision \cdot X ) - 1 ) << Header \cdot Shift \qquad Equation 1$$

$$Position [ i ] \cdot x = ( VertexBase \cdot X \& \sim DeltaMask \cdot X ) \vert ( ( VertexDeltas [ i ] \cdot X << Header \cdot Shift ) \& DeltaMask \cdot X )$$

$$Delta - Compressed Vertex Decode$$

In the above, the DeltaMask indicates which output bits are coming from the base vertex/radius values and which output bits are coming from the delta values indexed from Vertex Positions Array 203. The “Position” value is calculated by shifting by the amount specified in Header shift values and then applying the delta based on the delta mask. The above specifies calculations for the X axis, the same calculations being applied for Y and Z. The radius value will be similar but with a separate shift value applied (so different precision can be used for vertex and radius calculation).

An LSS primitive's ID is defined using the same delta compression scheme instead using PrimitiveID.Base 206, Precision.ID 240, and a delta from the “Primitive IDs Array” 205.

### Example Block Control Fields

As noted above, the example embodiment LSS primitive data block further includes metadata in the form of control fields. Example Block Control Fields (in this specification, a “field” can comprise a single bit of information or a plurality of bits or information).

### Relevant Block Fields:

Mode 210
NumPrims 214 (number of linear swept sphere primitives, where this value can be 1-N where N can be any integer such as tens, hundreds or thousands of primitives as limited by the overall size of the data block).

### Motion 226

These fields are block-wide control values in one embodiment, which define how the block is to be decoded. Mode field 210 defines the mode of the primitive block (mode is LSS in this case). NumPrims field 214 defines the number of LSS in the primitive block. See additional descriptions below.

### Per-LSS Fields (Vertex IDs Array)

### Relevant Block Fields and Example Interpretation:

i.Alpha 250—Is the LSS Alpha (transparent)?
i.Endcap0 252(i, 0)—Is endcap0 enabled?
i.Endcap1 252(i, 1)—Is endcap1 enabled?
i.chainStart 254—Is the LSS the start of a connected chain? (see implicitIndex=1).
i.v0 256(i, 0)—Vertex array index for vertex0/endcap0 (see implicitIndex=0).
i.v1 256 (i, 1)—Vertex array index for vertex1/endcap1 (see implicitIndex=0).

As noted above, in example embodiment each LSS has endcap enable indicators that enable endcap0 and endcap 1 independently for each LSS. If an endcap is enabled, the surface of the sphere of that endcap beyond the tangent circle is included as part of the LSS's surface for intersection testing. If an endcap is disabled, the surface of the sphere of that endcap beyond the tangent circle is not included as part of the LSS's surface for intersection testing—but either way, the sphere is still used to define the conical portion of the LSS. See FIG. 9.

As noted above, the metadata also supports alpha (transparency), with the same intersector operations applying as for triangles.

As noted above, each LSS also has a user-specified ID.

The Vertex IDs Array 204 defines a series of fields for every LSS, referred to as i.<field> throughout the following sections where ‘i’ is the LSS's index within the primitive block.

To improve compression, the data structure also allows certain fields to be constant for the data block so that such fields do not need to be processed on an LSS by LSS basis. In particular, in one embodiment the Constant Fields include:
ConstRadius 218
ConstAlpha 220
ConstEndcaps 222

These fields can either be set per-LSS/Vertex or stay constant for the primitive block to save space.

In example embodiments, when field 218 constRadius=1, VertexBase.R 202(R) is used directly, and Precision.R 238 and ShiftR 236 are not present and treated as 0. Since Precision.R 238 is 0, no per-vertex radii bits exist in the Vertex Positions Array 203.

When field 220 ConstAlpha=1, space is saved by forcing all LSS in the block to have the same alpha value as specified in the header for LSS0. This saves space in the “Vertex IDs Array” 204 as 0.a is applied for the whole block.

ConstEndcaps 222 behaves the same as ConstAlpha 220. If set, 0.endcap0 252(0, 0) and 0.endcap1 252(0, 1) control whether endcap0 and endcap1 are enabled for all LSSes in the entire block.

### Implicit Indexing

As noted above, the VertexPositions Array and the VertexIDs array are each indexed arrays that use indices to look up corresponding values for a particular LSS. Explicit indexes can be used to index these arrays. However, example embodiment also provide implicit indexing as a mechanism to save storage space, reduce latency, and reduce LSS definition communication bandwidth into the TTU. Many LSS use cases can be implicitly indexed. In some examples such as chaining, vertices are reused by adjacent LSSes. The example embodiment offers an implicit indexing mode in such cases to avoid storing redundant explicit index information. Even when vertices are not shared between LSSes, it is sometimes possible to access LSS vertices in a predetermined sequence so that implicit rather than explicit indexing can be employed (these implicit indexing modes do not necessarily reduce the number of vertices that are stored but can provide savings by reducing the number of explicit indexes that are stored).

### Relevant Block Fields:

ImplicitIndex 216

The ImplicitIndex header 216 controls the indexing mode of the block as summarized in the below table and shown in FIG. 11:

TABLE 1
LSS Primitive Block Indexing Modes

| ImplicitIndex Mode | Mode Definition |
|---|---|
| (0) Explicit Vertex | The VertexIDs array specifies explicit vertex |
| Indexing | indices for every LSS (i.v0, i.v1). |
| (1) Chains: Shared | Vertex indices are applied sequentially. |
| Implicit Indexing | i.chainStart forms a bit vector specifying which |
| | vertices are shared between neighboring LSS. |
| (2) Unconnected LSS: | Two vertex indices are applied sequentially per |
| Unshared Implicit | LSS. (No vertices are shared.) |
| Indexing | |
| (3) Spheres: Unshared | A single vertex index is applied sequentially per |
| Implicit Indexing | LSS, with both the v0 and v1 indices pointing |
| (see FIG. 7) | to that same vertex. (No vertices are shared |
| | between LSS.) The represented object is a |
| | single sphere in this degenerate version of the |
| | primitive, so only a single vertex and radius is |
| | used per LSS. This provides more compact |
| | encoding for spheres. |

Implicit Index Mode 1: Chains of LSSes such as shown in FIG. 13 are a common use (e.g., to represent hair) and for those we only need to specify when a new chain starts, as the vertices used along the chain can be implicitly defined. FIG. 6 shows an example of an object modeled using chained LSSes. This representation requires a small size of topology per LSS.

Implicit Index Mode 2: Even more compact is when all LSS are completely independent or unconnected (see second row in FIG. 13), in which case all vertices are implicit, which then requires no explicit index topology per LSS. This representation can be useful for ball and stick molecular models among other things. This mode can be used to represent chained LSSes in cases where the developer's data has explicitly repeated vertices and it's easier to use the data as is than to try to reform it into a shared vertex representation. Note that to increased efficiency, the AS builder (which typically comprises a processor or processing circuit such as a CPU and/or a GPU executing instructions stored in non-transitory memory, and may execute such instructions in advance of ray tracing run time or while the ray tracer is in operation in response to user inputs or other events) will generally place the LSSes falling within the same range (bounding volume) into a common data block so they can be intersection-tested together. There may be instances where the AS builder does not chain LSSes that could be chained, so that the unconnected LSSes can be bounded by a tighter bounding volume (or less overlapping bounding volumes) than a chain could be. This can increase culling efficiency at the bounding box-ray intersection stage, meaning that the LSS representations may never even need to be retrieved for presentation to the RPT for LSS-ray intersection testing. This can be useful for example for parallel strands in close proximity to one another. This unconnected mode is also quite flexible in representing any arrangement of LSSes but does involve repeating shared vertices.

Implicit Index Mode 3: Spheres (third row in FIG. 13) are a form of independent LSS, but only need 1 vertex instead of the 2 vertices in the independent implicit format. Since spheres are not chained, the vertices can easily be made fully implicit without any storage space spent on index topology. Spheres are especially useful for modeling particles as one example. There are other ways to model spheres using shaders, but using this primitive provides a fast path supported by hardware acceleration.

In example embodiments, indexing modes are not restricted to their listed use-cases, but there are tradeoffs when using one indexing mode where another would be optimal. The explicit topology can always be used for any set of LSSes but may not be as compressed or succinct as the implicit topologies. The chain topology can be used for individual segments but comes at the cost of extra topology storage space. The implicit unconnected LSS topology can be used for chains but comes at the (much) higher cost of replicated vertices. In example embodiments, the spheres topology generally would not be used for anything other than spheres.

Index Mode 4: Explicit Vertex Indexing

When implicitIndex=0; motion=0, every LSS primitive explicitly specifies two vertex indices in the “Vertex IDs Array” 204. This generates the following vertex indexing scheme:

$${lss}_{i} = ( i \cdot v 0 , i \cdot v 1 )$$

Equation 2 Explicit Vertex Indexing (implicitIndex=0; motion=0)

When implicitIndex=0;motion=1, where ‘i.v0/1’ define an explicit index within the primitive block's Vertex Positions Array 203, the start vertex indices are always even and the end vertex indices are always odd:

$$v 0 Idx \cdot start = 2 * i \cdot v 0$$

$$v 0 Idx \cdot end = 2 * i \cdot v 0 + 1$$

$$v 1 Idx \cdot start = 2 * i \cdot v 1$$

$$v 1 Idx \cdot end = 2 * i \cdot v 1 + 1$$

Equation 3 Explicit Vertex Indexing (implicitIndex=0; motion=1)

The bottom LSS structure of FIG. 13 is represented by explicit indices and shows that the developer can use explicit indexing to represent any arbitrary arrangement (chained, unchained, or a combination of both chained and unchained) of a multiplicity of LSSes. In this particular example, vertex v0 is shared three times—which the chaining model of mode 1 does not accommodate. The explicit indexing mode thus allows unlimited sharing of vertices between primitives but at the cost of explicitly indexing each vertex. This mode could also be very useful for molecular modeling as one example since vertices may be reused when building models of molecules.

### Shared Implicit Indexing

When implicitIndex=1; motion=0, no vertex indices are specified in the “Vertex IDs Array” 204. Instead the i.chainStart 254 field form a vector that marks lssᵢ as the start of a new connected LSS chain and therefore disconnected from lssᵢ₋₁. This means that the current LSS is not connected to the prior LSS in the block. LSS 0 does not have a chainStart bit as it has no prior LSS to reference.

If field 254 i.chainStart=0, the start vertex index of lssᵢ is the end of lssᵢ₋₁ (i.e., lssᵢ and lssᵢ₋₁ are connected). If field 254 i.chainStart=1, the start vertex index of lssᵢ is 1 after the end of lssᵢ₋₁ (i.e., lssᵢ and lssᵢ₋₁ are disconnected). This generates the following vertex index formula for lssᵢ, where the chainStart bits for lssᵢ and all prior LSS are summed:

$$v 0 Idx = i + SUM ( [ 1 : i ] \cdot chainStart ] ) \qquad Equation 4$$

$$v 1 Idx = v 0 Idx + 1$$

$$Shared Implicit Indexing ( implicitIndex = 1 ; motion = 0 )$$

When implicitIndex=1;motion=1, the same bit-vector of i.chainStart 254 is used and the formula updated to account for the additional implicit motion vertices. The start and end indices for lssᵢ are defined by:

$$v 0 Idx \cdot start = 2 * i + SUM ( [ 1 : i ] \cdot chainStart ) \qquad Equation 5$$

$$v 0 Idx \cdot end = 2 * i + SUM ( [ 1 : i ] \cdot chainStart ) + 1$$

$$v 1 Idx \cdot start = 2 * i + SUM ( [ 1 : i ] \cdot chainStart ) + 2$$

$$v 1 Idx \cdot end = 2 * i + SUM ( [ 1 : i ] \cdot chainStart ) + 3$$

$$Shared Implicit Indexing ( implicitIndex = 1 ; motion = 1 )$$

### Unshared Implicit Indexing

When implicitIndex=2; motion=0, the end vertex index of lssᵢ is 1 prior to the start of lssᵢ₊₁, and no vertices are specified in the “Vertex IDs Array” 206. This generates the vertex index pattern:

$$[ {lss}_{0} = ( 0 , 1 ) , {lss}_{1} = ( 2 , 3 ) , {lss}_{2} = ( 4 , 5 ) , … ] \qquad Equation 6$$

$$Unshared Implicit Indexing ( implicitIndex = 2 ; motion = 0 )$$

When implicitIndex=2;motion=1, because the end vertex index of lssᵢ is 1 prior to the start of lssᵢ₊₁, the following pattern for vertex indices results:
[lss₀. start=(0,2), lss₀. end=(1,3)], [lss₁. start=(4,6), lss₁. end=(5,7)], . . .

Therefore, when implicitIndex=2; motion=1 the start and end indices for lssᵢ are defined by:

$$v 0 Idx \cdot start = 4 * i \qquad Equation 7$$

$$v 0 Idx \cdot end = 4 * i + 1$$

$$v 1 Idx \cdot start = 4 * i + 2$$

$$v 1 Idx \cdot end = 4 * i + 3$$

$$Unshared Implicit Indexing ( implicitIndex = 2 ; motion = 1 )$$

### Unshared Implicit Indexing for Spheres

When implicitIndex=3; motion=0, an LSS start and end vertex index are equal (defining a sphere). The end vertex index of lssᵢ is 1 prior to the start of lssᵢ₊₁, and no vertices are specified in the “Vertex IDs Array”. This generates the vertex index pattern:

$$[ {lss}_{0} = ( 0 , 0 ) , {lss}_{1} = ( 1 , 1 ) , {lss}_{2} = ( 2 , 2 ) , … ] \qquad Equation 8$$

$$Unshared Implicit Indexing ( implicitIndex = 3 ; motion = 0 )$$

When implicitIndex=3;motion=1, lssᵢ is defined by a start sphere and an end sphere:
[lss₀. start=(0,0), lss₀. end=(1,1)], [lss₁. start=(2,2), lss₁. end=(3,3)], . . .

Therefore, when implicitIndex=3; motion=1 the start and end indices for lssᵢ are defined by:

$$v 0 Idx \cdot start = 2 * i \qquad Equation 9$$

$$v 0 Idx \cdot end = 2 * i + 1$$

$$v 1 Idx \cdot start = 2 * i$$

$$v 1 Idx \cdot end = 2 * i + 1$$

$$Unshared Implicit Indexing ( implicitIndex = 3 ; motion = 1 )$$

Implicit IDs

### Relevant Block Fields:

ImplicitID 216

When field 216 ImplicitID=1, the ID for primitive i will be PrimitiveID.Base 206+i, and the “Triangle/Primitive IDs array” is not present in the block.

TTU BVH Traversal with Linear-Swept Sphere

To traverse BVHs containing Linear-Swept Spheres, a TTU primitive range may now reference either LSS primitive blocks or the already supported triangle primitive blocks. During traversal, after the Ray Complet Test (RCT) sub-unit hits a primitive range leaf and the subsequent entries reach the top of the stack, the referenced primitive blocks are fetched from LOPC (a non-transitory memory that at one time or another stores each and every LSS primitive block of the type shown in FIG. 11 that the TTU processes or is to process) and the ray from RMU. Both are forwarded to RPT. To this point, the only modification to existing TTU behavior in one embodiment is that primitive ranges may contain an increased variable (specified) number of primitives.

If RPT determines the primitive block contains LSS, the entry ray-LSS tests occur for all LSS in the range and the Intersection Management Unit (IMU) will process and store the test results as required.

Alternatively, the RTCore driver may directly specify the primitive range stack entries through either of the existing primitive range stack-restore or a stack-initialization mechanisms.

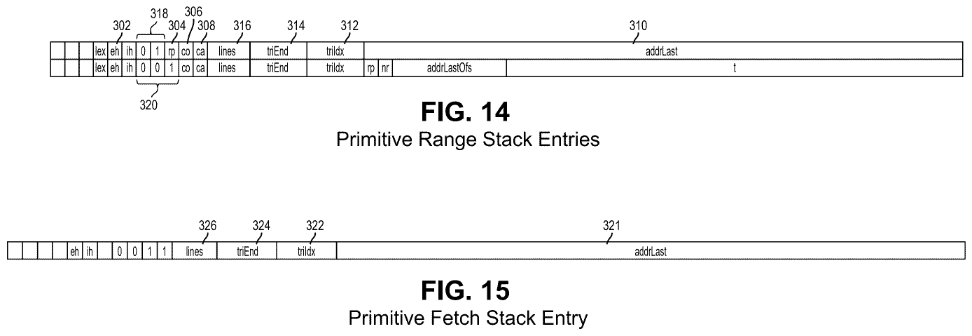

These methods permit one to request RPT to perform exit ray-LSS tests by setting the corresponding field in the primitive range stack entry (see FIG. 14).

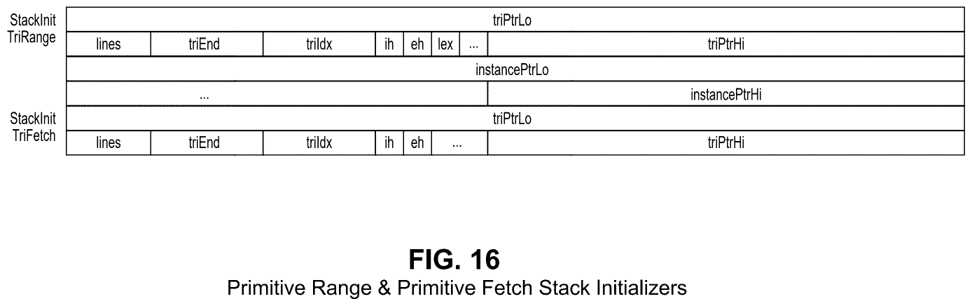

To fetch an LSS from the BVH, the RTCore driver may use the existing primitive fetch stack-initialization. See FIG. 16. If the stack-initialization references a primitive range containing LSS, RPT will detect the LSS block type, decode the LSS, and forward its attributes to IMU.

### Primitive Range Stack Entry

The Primitive Range stack entry shown in FIG. 14 defines primitive range intersection work. This range may contain LSS primitives. A primitive range is defined by the following fields:
exitHitTest (eh) 302
   Defines whether the RPT LSS intersection test should return the entry or exit LSS hit.
rayOpPass (rp) 304
   Specifies whether the combination rayOp, ray parameters, and complet child parameters result in a rayOp pass or fail. From this, RPT may modify the alpha mode of the LSS in the range.
cullOpaque (co) 306
   Specifies whether all opaque LSS in the range should be treated as misses.
cullAlpha (ca) 308
   Specifies whether all alpha LSS in the range should be treated as misses.
blockAddr (addrLast<<7) 310
triIdx 312
triEnd 314
lines 316

blockAddr 310, triIdx 312, triEnd 314, and lines 316 specify the extents of the primitive range in memory. blockAddr 310 specifies the address of the first primitive block in the range, triIdx 312 specifies the index of the first primitive within this block, lines 316 specifies the number of consecutive primitive blocks in the range, and triEnd 314 specifies the index of the last primitive in the last line. Every primitive range may reference a plethora of primitives across a multiplicity of primitive blocks.

In one embodiment, a primitive range stack entry may take two forms: A first primitive range entry or a subsequent primitive range entry. A subsequent entry is always accompanied by a first entry, and the blockAddr for the subsequent entry is defined as:
subsequent.blockAddr=(first.addrLast<<7)+subsequent.addrLastOfs

Additional bit fields 318, 320 shown in shaded portions are added to prepend to triIdx 312 and triEnd 314 in order to extend the primitive range.

In example embodiments, “lex” is a separate indicator in the stack entry. In example embodiments, instead of getting an exit hit through traversal as would happen with an entry hit query, the user needs to explicitly request an exit test query through either a stack restore or stack initialization. No exit test will occur during regular traversal in example embodiments. That exit query indicator “lex” is forwarded from the stack initialization into the stack entry and then down into RCT and then out through the primitive return. Usually, applications will want the entry hit. Therefore in example embodiments, the entry hit is automatically determined and reported unless the user specifically requests exit hit information by launching an additional query with either the same ray or potentially a different ray. The entry hit report provides sufficient information for the application to formulate an additional exit hit query for that same LSS.

### Primitive Fetch Stack Entry

The Primitive Fetch stack entry shown in FIG. 15 defines primitive fetch work which decodes and returns the first primitive within the specified range. An LSS is one such primitive. The following fields define this stack entry:
blockAddr (addrLast<<7)320
triIdx 322
triEnd 324
lines 326
   (see discussion above).

### Primitive Range & Primitive Fetch Stack Initializers

Primitive Range and Primitive Fetch stack initializers shown in FIG. 16 initialize the stack with their respective entries. Note the additional ih, eh and lex fields which can be used to request an exit hit test. In addition to the entry, the Primitive Range initializer may also push an instance node stack entry. An instance node stack entry specifies an instance node will first transform the ray (i.e., from world or ray space to primitive space) prior to the Primitive Range entry reaching the top of the stack.

### TTU Primitive Range Intersection & Fetch

When a Primitive Range or Primitive Fetch stack entry is encountered at the top of the stack, SMU activates TriSched. TriSched dispatches memory requests to LOPC for all primitive blocks in the range. As the primitive blocks are delivered through the memory hierarchy to LOPC, potentially out-of-order, the block data and range information is forwarded to RPT, while a request to RMU gathers the ray itself.

### RPT Ray-LSS Intersection Test Hardware Circuit Operation

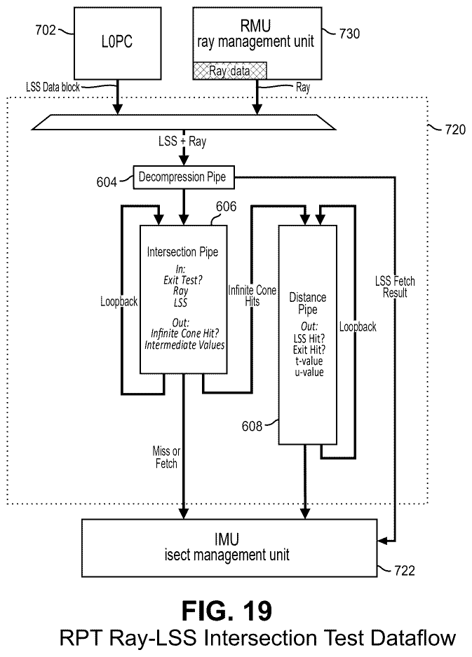

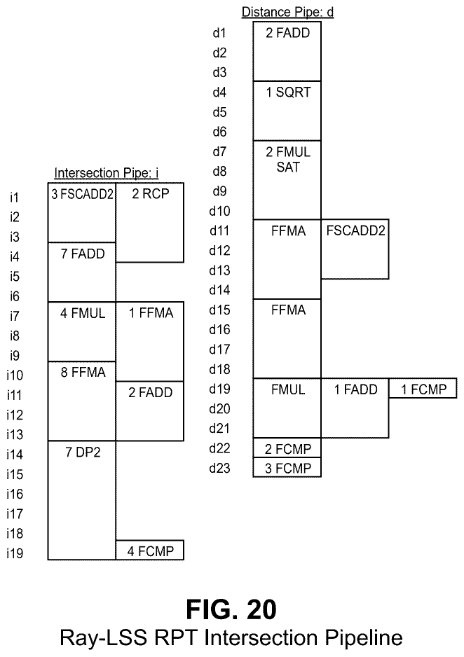

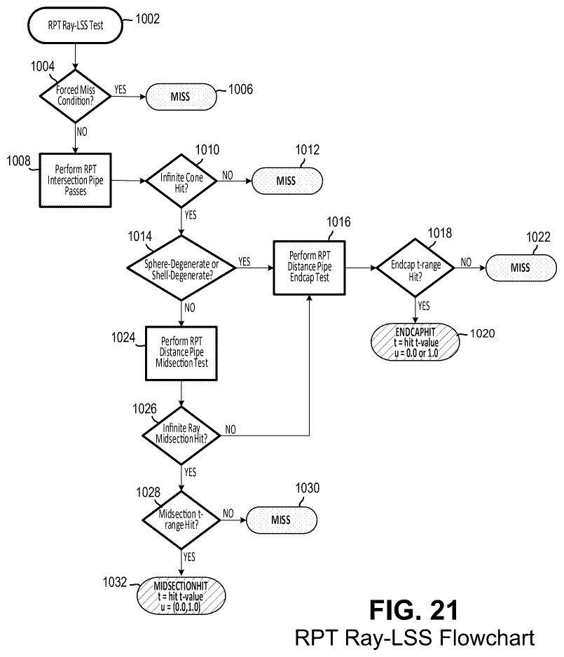

As RPT receives each LSS primitive block, it performs a ray-LSS intersection test for every LSS in the primitive range within that block. FIG. 19 RPT Ray-LSS Intersection Test Dataflow depicts the ray-LSS intersectors dataflow through RPT, FIG. 20 presents example mapping of this math to the RPT math pipeline circuit, and FIG. 21 presents a simplified flowchart of the ray-LSS intersection routine. In the FIG. 20 circuitry block diagram, each block represents a hardware computation circuit made of transistors, logic gates and other components fabricated on an integrated circuit silicon substrate. Such circuit blocks include floating point adder circuits (“FADD”), square root calculator circuits (“SQRT”), floating point multiplier circuits (“FMUL”), floating point compare circuits (“FCMP”), fused floating-point multiply-add circuits (“FFMA”—see e.g., U.S. Pat. No. 9,465,575), fused 2-component dot product units (“DP2”), 2-component floating-point scaled add (“FSCADD2”) and other circuits. These computation circuits are configured to compute dot products and other simple, fast floating point calculations in hardware to test the origin/direction of the incoming ray against the conical surface and endcaps (if present) of the LSS primitive (see FIG. 5).

In example embodiments, the circuitry shown is pipelined in the sense that different stages of the circuitry can be working on different data in succession, much like a clothes dryer can be drying one load of clothes while a washing machine is washing the next load of clothes. In example embodiments, the circuitry shown is multipass in that it can be configured to perform different operations on the same data (or results of a previous operation(s) on the same data) in different passes. The “loopback” connections shown in FIG. 19 enable these multiple passes. Additionally, there can be multiple copies of the FIG. 20 circuitry fabricated on the semiconductor wafer(s) so the pipelined operations shown can be performed concurrently in parallel for different primitives or for different stages of the same primitives. Such “multilane” operation is constructed to ensure all operations performed by all lanes are consistent with one another to avoid different lanes causing different visualization effects.

In example embodiments, portions of the RPT circuit 720 are stateless. Specifically for example, the FIG. 20 RPT multipass intersection pipeline calculation circuitry is ready for a next pass (or a next primitive) immediately upon completing operations for a last pass (or a last primitive). There is no need to flush the calculation circuitry to prepare for a next pass or primitive nor is there any need for any execution context switch, interrupt processing, etc. In fact, in the pipelined operation shown, one part of the calculation circuitry can operate on one primitive while another part of the calculation circuitry can simultaneously operate on a different primitive. As an intersection test flows through the pipeline, the necessary state for that test is passed in either FLOPs or RAM along with it. When multiple passes are required, the state is passed back to the front of the pipeline in the loopback of FIG. 19. And, as mentioned above, multiple replications (“lanes”) of the FIG. 20 circuitry can be provided so one lane can operate on one primitive data block while another lane can operate on a different primitive data block. Furthermore, the FIG. 19 RTP circuit in example embodiments continues to perform intersection testing for all supported primitive types—namely in this embodiment, both triangle primitives and LSS primitives. The LOPC primitive cache (formerly “triangle cache”) can store any number of triangle primitive data blocks and any number of LSS primitive data blocks (consistent with LOPC storage requirements). The FIG. 19 RTP circuitry's multiplexer can select which parts of which data block to present to the decompression pipe 604 and the intersection pipe 606 such that no additional explicit copy of the primitive data block(s) needs to be made internally by the RPT 720 for each intersection test. Once again, no suspension of operation or context switch of the intersection pipe 606 is required when operating on different primitives from the same data block or different primitives from different data blocks—even if one data block contains LSS primitives and another data block contains triangle primitives. Instead, the RTP 720 is configured to be occupied with work all of the time so that as quickly as it is finished processing last primitive data it can demand and begin processing next primitive data and associated ray information.

When RPT receives an LSS primitive block (as indicated by the LSS Header of the block) from the LOPC 500 as shown in FIG. 19 for a given primitive range, it generates a series of ray-LSS intersection tests (FIG. 21, 1002) as follows:

The primitive block is decoded in the RPT Decompression Pipe 604, which decodes all information for each LSS in the range.

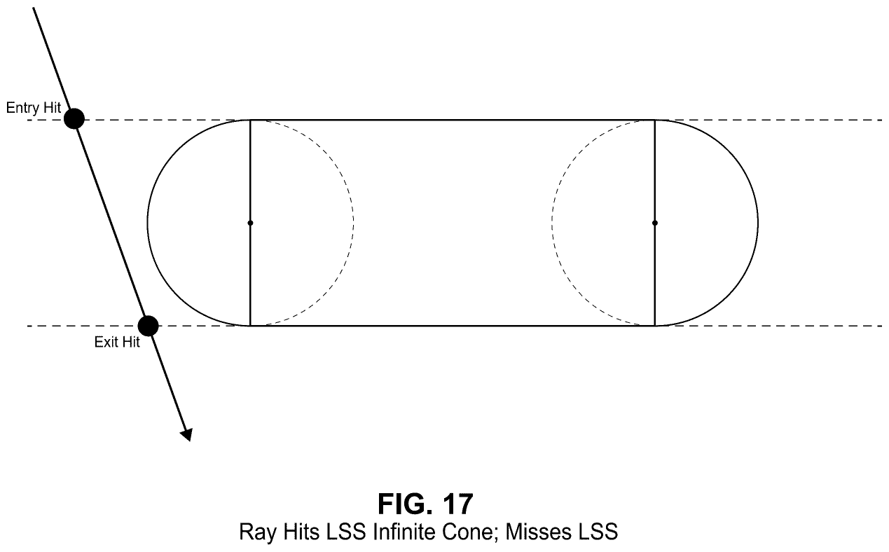

The decoded primitive block from the RPT Decompression Pipe 604 and the ray provided by RMU 502 will then both flow through to the intersection pipe (hardware intersector) 606. At a high level, the intersector 606 determines either the entry hit or the exit hit on the infinite cone extension of the LSS (see FIG. 17).

In particular, across multiple passes through the intersector 606 (FIG. 21 block 1008), the RPT Intersection Pipe determines whether the infinite cone of the LSS is hit by the infinite extension of the ray (FIG. 21 block 1010). The infinite cone of the LSS is the geometry formed by extending the midsection infinitely beyond both endcaps (See FIG. 17). The intersector 606 attempts to determine whether the ray has hit the infinite cone or not.

If the ray or LSS contains any infinite or NaN component, a miss is forced (FIG. 21 blocks 1010, 1012).

If both radii of the LSS are zero or negative, a miss is forced (FIG. 21 blocks 1004, 1006).

If the LSS is sphere-degenerate and both endcaps are disabled or if the LSS is shell-degenerate with only the negative radius endcap enabled, a miss is forced (FIG. 21 blocks 1014, 1016, 1018, 1022). FIG. 10 is a graphical interpretation of this scenario showing a negative radius LSS. The LSS becomes intersectable when the interpolated radii goes from negative to positive. The portion of the LSS defined by negative radii is invisible from the standpoint of intersection, which is why a miss is forced when only the negative radius endcap is enabled. However, if both the endcap with the negative radius and the endcap with the positive radius are enabled, the positive radius endcap is tested.

If the infinite cone of the LSS is intersected by the ray, and a miss is not forced, the ray-LSS intersection test proceeds through the RPT Distance Pipe 608 (FIG. 21 block 1024). The job of the distance pipe circuit 608 is to determine the t and u values of the hit. The distance pipe 608 takes one or two passes to make these determinations. The distance pipe 608 can make the determination for a sphere or shell degenerate LSS in one pass, but a non-degenerate LSS may take two passes. The multiple passes allows sharing of math units such as shown in FIG. 20 between different processes while avoiding the need for an expanded semiconductor wafer area to accommodate additional calculation transistor circuitry.

The RPT Distance Pipe 608 first determines (in the first pass) if the infinite extension of the ray intersects the midsection (FIG. 21 block 1026). If so, a midsection hit is returned if the hit point's t-value is within the ray's t-range (1028, 1032).

Otherwise, the distance pipe 608 performs another distance pass to test intersection of the ray against the enabled endcap closest to the infinite cone hit point (FIG. 21 blocks 1016). The distance pipe 608 computes a midsection u value in the first pass; if the computed u value is less than 0 or greater than 1, it uses this to determine which endcap to test against. If the endcap is hit, and the hit point's t-value is within the ray's t-range, an endcap hit is returned (FIG. 21 blocks 1020). In this endcap hit case, there is no u value to return because the u value does not accurately apply out of the range of 0≤u≤1 (see FIG. 5).

For sphere-degenerate and shell-degenerate LSS, the RPT Intersection Pipe infinite-cone check is forced to pass and the midsection RPT Distance Pipe test skipped.

For sphere-degenerate LSS, if the LSS is hit, the hit is returned on endcap1 by default. If endcap1 is disabled, the hit is returned on endcap0.

For shell-degenerate LSS with two positive radii, the outermost enabled endcap is tested. For shell-degenerate LSS with one positive radii, the positive radius endcap is tested. In each of these cases, the midsection intersection test can be skipped.

### IMU LSS Hit Processing

IMU receives a packet for all LSS intersection pipe and distance pipe hits and tracks the closest hit in a range to ultimately update the ray's closest hit and the TTU stack on completion of primitive range testing.

IMU may receive LSS hits in a different order than the LSS exist in the primitive range due to (1) the potential out-of-order delivery of primitive blocks in a range to RPT and/or (2) the potential out-of-order delivery of hits within a primitive block due to variable number of RPT passes for different LSSes in the same block (that is, one LSS in a block can take more or less time for RPT to process than another LSS within the same block). This is different from how RPT processes triangles in the order they are presented. For this reason, IMU in example embodiments is able to track the block and primitive index for every hit and force a hit on the earlier LSS in the case of a t-value tie.

In addition, IMU handles processing of LSS marked as alpha. Alpha LSS is in one embodiment returned to the called “SM” streaming multiprocessor for processing in an AnyHit shader to determine if they should be treated as hits or misses.

For alpha LSS the following hit rules may be applied in IMU:

For alpha hits after an existing alpha hit, IMU stores the alpha hit earliest in the primitive range.

The primitive range stack entry is incremented past that alpha hit, and the cullOpaque bit is set.

For alpha hits after an existing opaque hit, IMU stores the opaque hit.

If the alpha hit has a smaller hit t-value, the primitive range stack entry is updated to point to the opaque hit and cullOpaque is set.

### TIF LSS Hit and Fetch Return

LSS return data from the TTU takes two forms: LSS hit returns and LSS fetch returns.

An LSS hit return contains the following information as shown in FIG. 22:
Hit LSS's primitiveID
Hit point ‘t’ and ‘u’ values produced by the RPT ray-LSS test
Flag indicating whether the RPT ray-LSS test, and therefore hit point, was an entry (lex=0) or exit test (lex=1)
Hit LSS's alpha flag (a)

An LSS fetch return (i.e., a data block the TTU provides to the CPU, SM or other requesting processor in response to a “fetch” operation by that processor) contains the following information as shown in FIG. 23:
Fetched LSS's vertex positions and radii
Fetched LSS's primitiveID
Fetched LSS's endcap enable flags
Fetched LSS's alpha flag
Fetched LSS's primitive range information excluding cullOpaque, cullAlpha, and rayOpPass.

Referring to FIG. 19, the RPT handles the fetch by passing the decompressed LSS data block (or pertinent portions thereof) through the intersection pipe 606 to the IMU. This allows a CPU to read the AS LSS data block currently being presented to the TTU.

### Motion Support

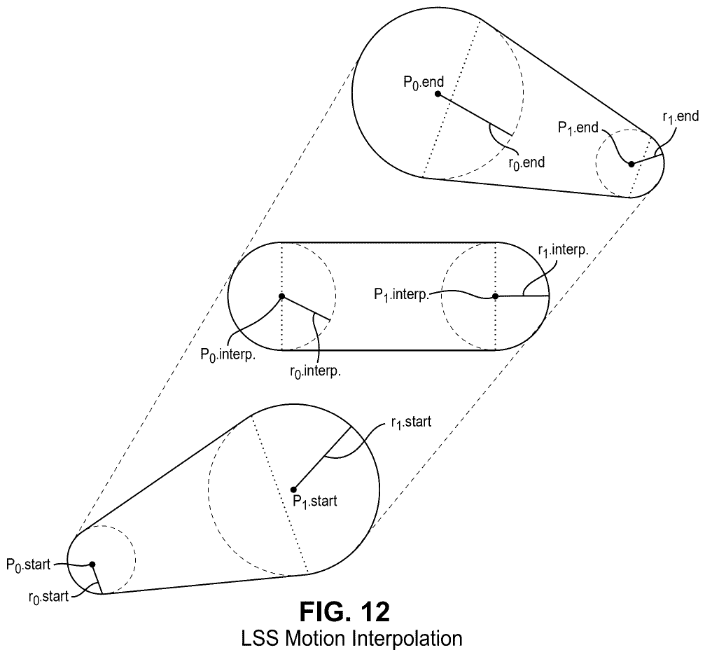

As explained above, example embodiments support a motion feature with respect to LSS. This can be very useful for example to show hair twirling or blowing in the wind, or grass blades moving in the wind. This motion feature enables the intersector to use a time or t range or instant of the ray to interpolate between a first LSS and a second LSS thereby defining an interpolated LSS at the instant of the ray. See FIG. 12. If Motion 226 is set in the FIG. 11 data block, the block defines motion LSS, for which v0 and v1 is calculated by interpolating between start/end v0 vertices and start/end v1 vertices, respectively of a first specified LSS and a second specified LSS. Hardware computation circuits such as described above can be used to calculate linearly interpolated values P₀.interp, r₀.interp, P₁.interp, r₁.interp at the instant of the incoming ray for intersection testing with the swept sphere primitive. In the same manner as motion triangles, linear interpolation is performed using the ray's timestamp.

Whereas non-motion LSS are defined by two vertex indices v0 and v1, motion LSS are defined by 4 vertex indices: v0start=v0; v0end=v0start+1; v1start=v1; and v1end=v1start+1. The vertex indices v0end and v1end are implicit in example embodiments.

The TTU provides hardware acceleration for these moving LSS primitives. U.S. Ser. No. 11/373,358 describes hardware support for triangle primitive motion, which has been extended in example embodiments herein to support LSS primitive motion. When an LSS block is specified as motion, the vertices for the specified primitive are linearly interpolated. The RPT 720 interpolation uses full (e.g., FP32) precision to interpolate the vertices since in one embodiment the ray-geometry intersection test is exact. For details concerning example linear interpolation techniques that can be used, see FIGS. 4, 4A, 5 & 5A of U.S. Ser. No. 11/373,358. In one embodiment, the RPT 720 implementation again uses a multi-pass approach where a first pass or passes linearly interpolates between vertices or center/radius, and then a further pass or passes performs a typical intersection test against the interpolated LSS primitive as described above.

In one embodiment, the RPT 720 processes vertices in parallel. For “watertightness” (triangle meshes) and reasons, all vertices are interpolated in the same manner independently of the lane used. If not, then adjacent primitives that use the same vertices but have those vertices go down different vertex processing lanes might see those vertices at different interpolated points for the same timestamp, thereby introducing holes in the mesh and creating associated artifacts. In one embodiment, fetch is supported for motion primitives. The timestamp specified via the RayFlags write will be used if present. In one embodiment, the following behavior holds: If timestamp==0.Of or if no timestamp is specified, then the vertices for the beginning LSS primitive are returned without interpolation. If timestamp==1.0f, then the vertices for the end LSS primitive are returned without interpolation. If timestamp >0.0f and <1.0f, then the interpolated LSS vertices are returned. If index is >num motion primitive or the timestamp is <0.0f, >1.0f, or ?0.0f, then the return will be all zeros for vertices, ID, and alpha, just like an invalid index for non-motion/static primitives. If a fetch targets a static LSS block, then the timestamp will be ignored completely, and the fetch will be treated as a normal static LSS primitive fetch. Primitive fetch (see above) allows an LSS primitive to be pulled out of the compressed LSS block used by the hardware for traversal. This is support for motion primitives by supplying a timestamp along with the fetch query that will allow for interpolation or key selection. A timestamp is not required for a fetch, and if absent, the vertices for the primitive at the beginning of the range will be returned.

The following additional discussion is provided for context and completeness.

### Example System Block Diagram

The following describes an overall example non-limiting real time ray tracing system with which the present technology can be used. In particular, while the acceleration structure constructed as described above can be used to advantage by software based graphics pipeline processes running on a conventional general purpose computer, the presently disclosed non-limiting embodiments advantageously implement the above-described techniques in the context of a hardware-based graphics processing unit including a high performance processors such as one or more streaming multiprocessors (“SMs”) and one or more traversal co-processors or “tree traversal units” (“TTUs”) subunits of one or a group of streaming multiprocessor SMs of a 3D graphics processing pipeline. The following describes the overall structure and operation of such as system including a TTU 138 that accelerates certain processes supporting interactive ray tracing including ray-bounding volume intersection tests, ray-primitive intersection tests and ray “instance” transforms for real time ray tracing and other applications.

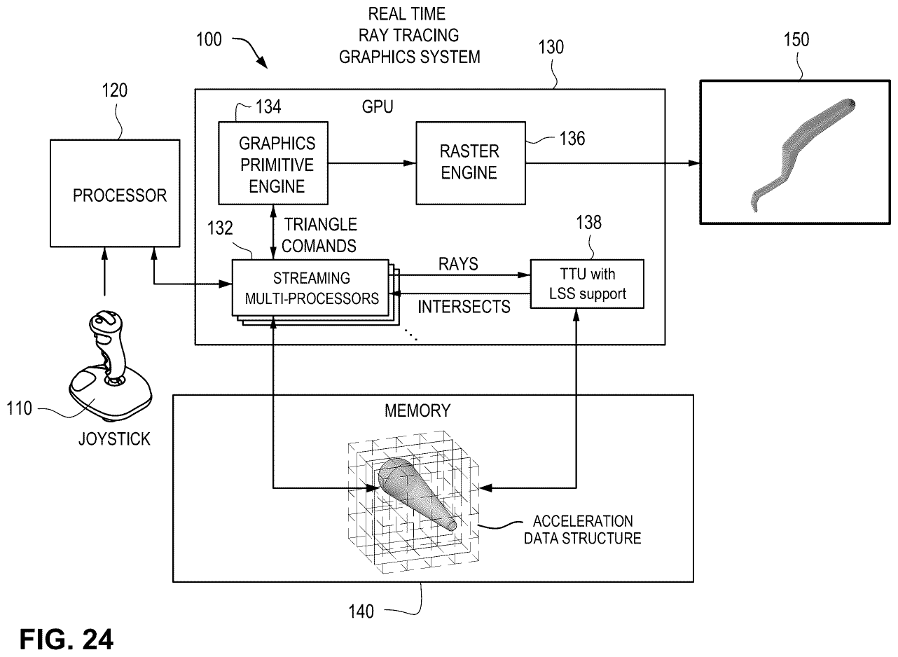

FIG. 24 illustrates an example real time ray interactive tracing graphics system 100 for generating images using three dimensional (3D) data of a scene or object(s) including the acceleration data structure including LSS primitives constructed as described above.

System 100 includes an input device 110, a processor(s) 120, a graphics processing unit(s) (GPU(s)) 130, memory 140, and a display(s) 150. The system shown in FIG. 24 can take on any form factor including but not limited to a personal computer, a smart phone or other smart device, a video game system, a wearable virtual or augmented reality system, a cloud-based computing system, a vehicle-mounted graphics system, a system-on-a-chip (SoC), etc.

The processor 120 may be a multicore central processing unit (CPU) operable to execute an application in real time interactive response to input device 110, the output of which includes images for display on display 150. Display 150 may be any kind of display such as a stationary display, a head mounted display such as display glasses or goggles, other types of wearable displays, a handheld display, a vehicle mounted display, etc. For example, the processor 120 may execute an application based on inputs received from the input device 110 (e.g., a joystick, an inertial sensor, an ambient light sensor, etc.) and instruct the GPU 130 to generate images showing application progress for display on the display 150.

Based on execution of the application on processor 120, the processor may issue instructions for the GPU 130 to generate images using 3D data stored in memory 140. The GPU 130 includes specialized hardware for accelerating the generation of images in real time. For example, the GPU 130 is able to process information for thousands or millions of graphics primitives (polygons) in real time due to the GPU's ability to perform repetitive and highly-parallel specialized computing tasks such as polygon scan conversion much faster than conventional software-driven CPUs. For example, unlike the processor 120, which may have multiple cores with lots of cache memory that can handle a few software threads at a time, the GPU 130 may include hundreds or thousands of processing cores (one example type of which may be an NVIDIA “streaming multiprocessor” (SMs)) 132 running in parallel.

In one example embodiment, the GPU 130 includes a plurality of programmable such high performance processors 132, and a hardware-based graphics pipeline including a graphics primitive engine 134 and a raster engine 136. These components of the GPU 130 are configured to perform real-time image rendering using a technique called “scan conversion rasterization” to display three-dimensional scenes on a two-dimensional display 150. In rasterization, geometric building blocks (e.g., points, lines, triangles, quads, meshes, spheres, curves, etc.) of a 3D scene are mapped to pixels of the display (often via a frame buffer memory).

The GPU 130 converts the geometric building blocks (i.e., primitives such as triangles and LSS primitives) of the 3D model into pixels of the 2D image and assigns an initial color value for each pixel. The graphics pipeline may apply shading, transparency, texture and/or color effects to portions of the image by defining or adjusting the color values of the pixels. The final pixel values may be anti-aliased, filtered and provided to the display 150 for display. Many software and hardware advances over the years have improved subjective image quality using rasterization techniques at frame rates needed for real-time graphics (i.e., 30 to 60 frames per second) at high display resolutions such as 4096×2160 pixels or more on one or multiple displays 150.

To enable the GPU 130 to perform ray tracing in real time in an efficient manner, the GPU provides one or more “TTUs” 138 coupled to one or more SMs 132. The TTU 138 includes hardware components configured to perform (or accelerate) operations commonly utilized in ray tracing algorithms. A goal of the TTU 138 is to accelerate operations used in ray tracing to such an extent that it brings the power of ray tracing to real-time graphics application (e.g., games), enabling high-quality shadows, reflections, and global illumination. Results produced by the TTU 138 may be used together with or as an alternative to other graphics related operations performed in the GPU 130.

More specifically, SMs 132 and the TTU 138 may cooperate to cast rays into a 3D model and determine whether and where that ray intersects the model's geometry. Ray tracing directly simulates light traveling through a virtual environment or scene. The results of the ray intersections together with surface texture, viewing direction, and/or lighting conditions are used to determine pixel color values. Ray tracing performed by SMs 132 working with TTU 138 allows for computer-generated images to capture shadows, reflections, and refractions in ways that can be indistinguishable from photographs or video of the real world. Since ray tracing techniques are even more computationally intensive than rasterization due in part to the large number of rays that need to be traced, the TTU 138 is capable of accelerating in hardware certain of the more computationally-intensive aspects of that process.

Given an acceleration data structure including a BVH constructed as described above, the TTU 138 performs a tree search where each node in the tree visited by the ray has a bounding volume for each descendent branch or leaf, and the ray only visits the descendent branches or leaves whose corresponding bound volume it intersects. In this way, TTU 138 explicitly tests only a small number of primitives for intersection, namely those that reside in leaf nodes intersected by the ray. In the example non-limiting embodiments, the TTU 138 accelerates both tree traversal (including the ray-volume tests) and ray-primitive tests. As part of traversal, it can also handle at least one level of instance transforms, transforming a ray from world-space coordinates into the coordinate system of an instanced mesh. In the example non-limiting embodiments, the TTU 138 does all of this in MIMD fashion, meaning that rays are handled independently once inside the TTU.

In the example non-limiting embodiments, the TTU 138 operates as a servant (coprocessor) to the SMs (streaming multiprocessors) 132. In other words, the TTU 138 in example non-limiting embodiments does not operate independently, but instead follows the commands of the SMs 132 to perform certain computationally-intensive ray tracing related tasks much more efficiently than the SMs 132 could perform themselves. In other embodiments or architectures, the TTU 138 could have more or less autonomy.

In the examples shown, the TTU 138 receives commands via SM 132 instructions and writes results back to an SM register file. For many common use cases (e.g., opaque primitives with at most one level of instancing), the TTU 138 can service the ray tracing query without further interaction with the SM 132. More complicated queries (e.g., involving alpha-tested triangles, primitives other than triangles, or multiple levels of instancing) may require multiple round trips (although the technology herein reduces the need for such “round trips” for certain kinds of geometry by providing the TTU 138 with enhanced capabilities to autonomously perform ray-bounding-volume intersection testing without the need to ask the calling SM for help). In addition to tracing rays, the TTU 138 is capable of performing more general spatial queries where an AABB or the extruded volume between two AABBs (which we call a “beam”) takes the place of the ray. Thus, while the TTU 138 is especially adapted to accelerate ray tracing related tasks, it can also be used to perform tasks other than ray tracing.

The TTU 138 thus autonomously performs a test of each ray against a wide range of bounding volumes, and can cull any bounding volumes that don't intersect with that ray. Starting at a root node that bounds everything in the scene, the traversal co-processor tests each ray against smaller (potentially overlapping) child bounding volumes which in turn bound the descendent branches of the BVH. The ray follows the child pointers for the bounding volumes the ray hits to other nodes until the leaves or terminal nodes (volumes) of the BVH are reached.

Once the TTU 138 traverses the acceleration data structure to reach a terminal or “leaf” node (which may be represented by one or multiple bounding volumes) that intersects the ray and contains a geometric primitive, it performs a hardware-accelerated ray-primitive intersection test to determine whether the ray intersects that primitive (and thus the object surface that primitive defines). The ray-primitive test can provide additional information about primitives the ray intersects that can be used to determine the material properties of the surface required for shading and visualization. Recursive traversal through the acceleration data structure enables the traversal co-processor to discover all object primitives the ray intersects, or the closest (from the perspective of the viewpoint) primitive the ray intersects (which in some cases is the only primitive that is visible from the viewpoint along the ray). See e.g., Lefrancois et al, NVIDIA Vulkan Ray Tracing Tutorial, December 2019, https://developer.nvidia.com/rtx/raytracing/vkray

As mentioned above, the TTU 138 also accelerates the transform of each ray from world space into object space to obtain finer and finer bounding box encapsulations of the primitives and reduce the duplication of those primitives across the scene. As described above, objects replicated many times in the scene at different positions, orientations and scales can be represented in the scene as instance nodes which associate a bounding box and leaf node in the world space BVH with a transformation that can be applied to the world-space ray to transform it into an object coordinate space, and a pointer to an object-space BVH. This avoids replicating the object space BVH data multiple times in world space, saving memory and associated memory accesses. The instance transform increases efficiency by transforming the ray into object space instead of requiring the geometry or the bounding volume hierarchy to be transformed into world (ray) space and is also compatible with additional, conventional rasterization processes that graphics processing performs to visualize the primitives.

### Example Ray Tracing Processes

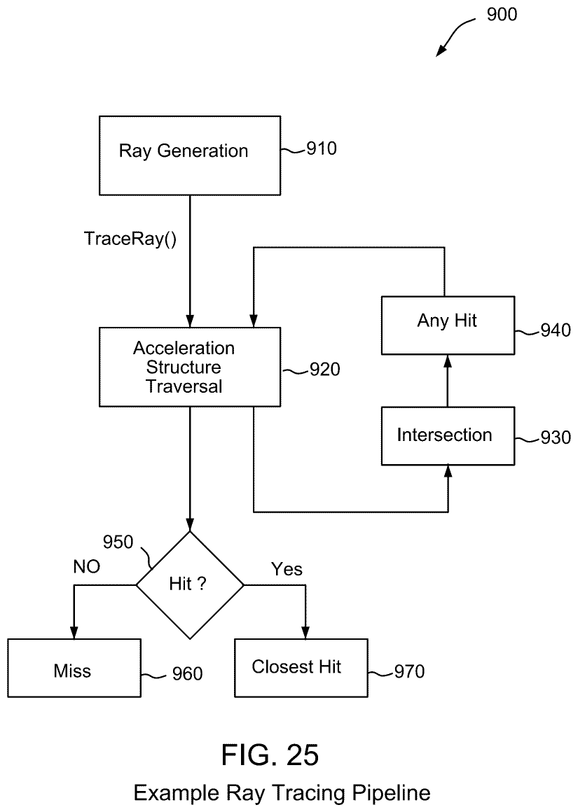

FIG. 25 shows an exemplary ray tracing shading pipeline 900 that may be performed by SM 132 and accelerated by TTU 138. The ray tracing shading pipeline 900 starts by an SM 132 invoking ray generation 910 and issuing a corresponding ray tracing request to the TTU 138. The ray tracing request identifies a single ray cast into the scene and asks the TTU 138 to search for intersections with an acceleration data structure the SM 132 also specifies. The TTU 138 traverses the acceleration data structure to determine intersections or potential intersections between the ray and the volumetric subdivisions and associated primitives the acceleration data structure represents. Potential intersections can be identified by finding bounding volumes in the acceleration data structure that are intersected by the ray. Descendants of non-intersected bounding volumes need not be examined.

For triangles and LSS primitives within intersected bounding volumes, the TTU 138 ray-primitive test block 720 performs an intersection 930 process to determine whether the ray intersects the primitives. The TTU 138 returns intersection information to the SM 132, which may perform an “any hit” shading operation 940 in response to the intersection determination. For example, the SM 132 may perform (or have other hardware perform) a texture lookup for an intersected primitive and decide based on the appropriate texel's value how to shade a pixel visualizing the ray. The SM 132 keeps track of such results since the TTU 138 may return multiple intersections with different geometry in the scene in arbitrary order.

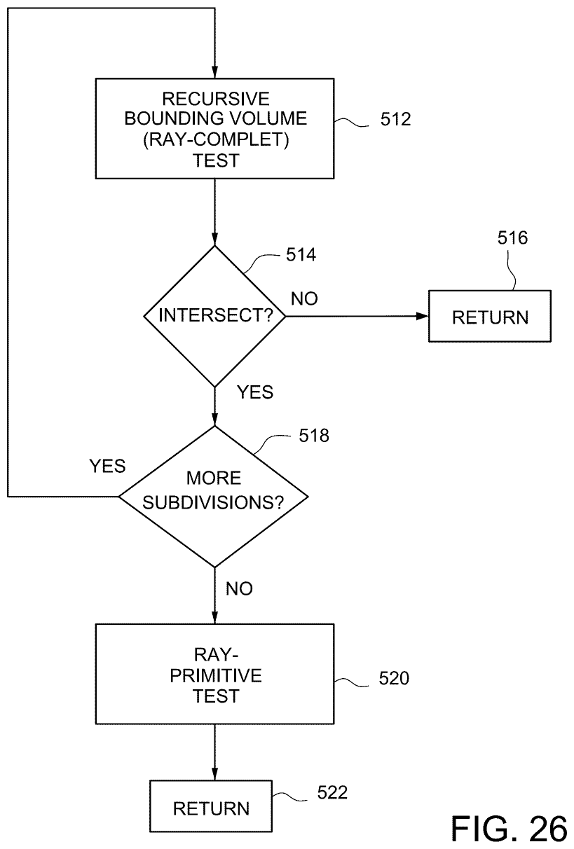

FIG. 26 is a flowchart summarizing example ray tracing operations the TTU 138 performs as described above in cooperation with SM(s) 132. The FIG. 26 operations are performed by TTU 138 in cooperation with its interaction with an SM 132. The TTU 138 may thus receive the identification of a ray from the SM 132 and traversal state enumerating one or more nodes in one or more BVH's that the ray must traverse. The TTU 138 determines which bounding volumes of a BVH data structure the ray intersects (the “ray-complet” test 512). The TTU 138 can also subsequently determine whether the ray intersects one or more primitives in the intersected bounding volumes and which primitives are intersected (the “ray-primitive test” 520) or the SM 132 can perform this test in software if it is too complicated for the TTU to perform itself. In example non-limiting embodiments, complets specify root or interior nodes (i.e., volumes) of the bounding volume hierarchy with children that are other complets or leaf nodes of a single type per complet.

First, the TTU 138 inspects the traversal state of the ray. If a stack the TTU 138 maintains for the ray is empty, then traversal is complete. If there is an entry on the top of the stack, the traversal co-processor 138 issues a request to the memory subsystem to retrieve that node. The traversal co-processor 138 then performs a bounding box test 512 to determine if a bounding volume of a BVH data structure is intersected by a particular ray the SM 132 specifies (step 512, 514). If the bounding box test determines that the bounding volume is not intersected by the ray (“No” in step 514), then there is no need to perform any further testing for visualization and the TTU 138 can return this result to the requesting SM 132. This is because if a ray misses a bounding volume, then the ray will miss all other smaller bounding volumes inside the bounding volume being tested and any primitives that bounding volume contains.

If the bounding box test performed by the TTU 138 reveals that the bounding volume is intersected by the ray (“Yes” in Step 514), then the TTU determines if the bounding volume can be subdivided into smaller bounding volumes (step 518). In one example embodiment, the TTU 138 isn't necessarily performing any subdivision itself. Rather, each node in the BVH has one or more children (where each child is a leaf or a branch in the BVH). For each child, there is one or more bounding volumes and a pointer that leads to a branch or a leaf node. When a ray processes a node using TTU 138, it is testing itself against the bounding volumes of the node's children. The ray only pushes stack entries onto its stack for those branches or leaves whose representative bounding volumes were hit. When a ray fetches a node in the example embodiment, it doesn't test against the bounding volume of the node—it tests against the bounding volumes of the node's children. The TTU 138 pushes nodes whose bounding volumes are hit by a ray onto the ray's traversal stack in an order determined by ray configuration. For example, it is possible to push nodes onto the traversal stack in the order the nodes appear in memory, or in the order that they appear along the length of the ray, or in some other order. If there are further subdivisions of the bounding volume (“Yes” in step 518), then those further subdivisions of the bounding volume are accessed and the bounding box test is performed for each of the resulting subdivided bounding volumes to determine which subdivided bounding volumes are intersected by the ray and which are not. In this recursive process, some of the bounding volumes may be eliminated by test 514 while other bounding volumes may result in still further and further subdivisions being tested for intersection by TTU 138 recursively applying steps 512-518.

Once the TTU 138 determines that the bounding volumes intersected by the ray are leaf nodes (“No” in step 518), the TTU 138 and/or SM 132 performs a primitive (e.g., triangle or LSS as appropriate) intersection test 520 to determine whether the ray intersects primitives in the intersected bounding volumes and which primitives the ray intersects. The TTU 138 thus performs a depth-first traversal of intersected descendent branch nodes until leaf nodes are reached. The TTU 138 processes the leaf nodes. If the leaf nodes are primitive ranges, the TTU 138 or the SM 132 tests them against the ray. If the leaf nodes are instance nodes, the TTU 138 or the SM 132 applies the instance transform. If the leaf nodes are item ranges, the TTU 138 returns them to the requesting SM 132.

In the example non-limiting embodiments, the SM 132 can command the TTU 138 to perform different kinds of ray-primitive intersection tests and report different results depending on the operations coming from an application (or a software stack the application is running on) and relayed by the SM to the TTU. For example, the SM 132 can command the TTU 138 to report the nearest visible primitive revealed by the intersection test, or to report all primitives the ray intersects irrespective of whether they are the nearest visible primitive. The SM 132 can use these different results for different kinds of visualization. Or the SM 132 can perform the ray-primitive intersection test itself once the TTU 138 has reported the ray-complet test results. Once the TTU 138 is done processing the leaf nodes, there may be other branch nodes (pushed earlier onto the ray's stack) to test.

### Example Non-Limiting TTU 138 Hardware Implementation

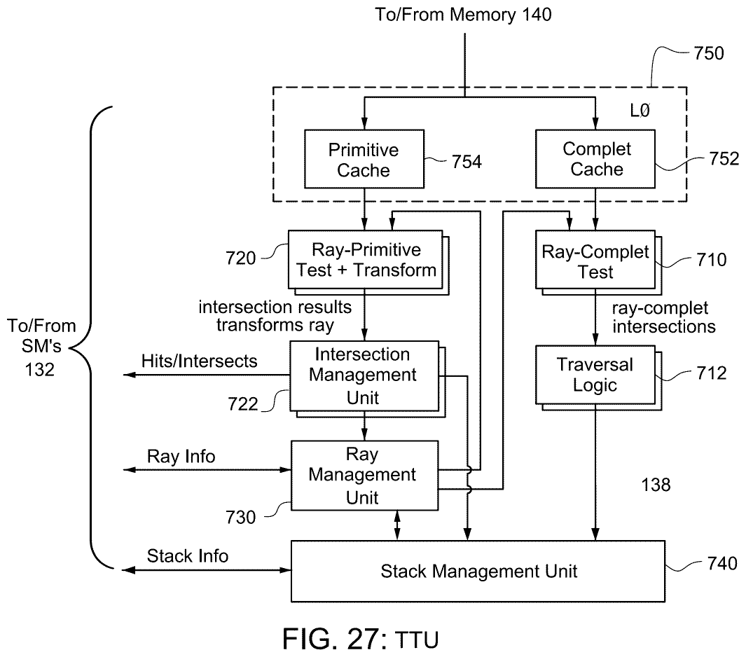

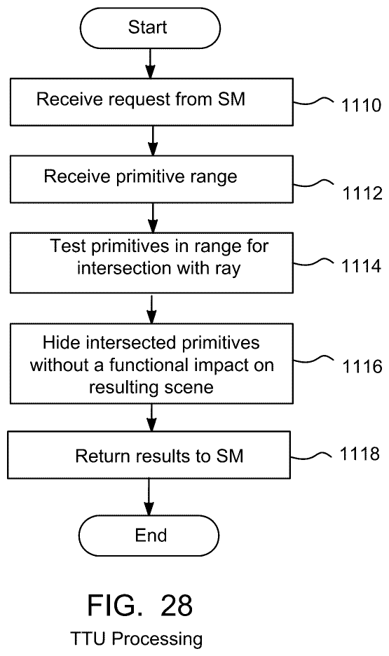

FIG. 27 shows an example simplified block diagram of TTU 138 including hardware configured to perform accelerated traversal operations as described above. In some embodiments, the TTU 138 may perform a depth-first traversal of a bounding volume hierarchy using a short stack traversal with intersection testing of supported leaf node primitives and mid-traversal return of alpha primitives and unsupported leaf node primitives (items). The TTU 138 includes dedicated hardware to determine whether a ray intersects bounding volumes and dedicated hardware to determine whether a ray intersects primitives of the tree data structure. In the example shown, linear interpolation for ray-bounding box test is performed in the ray-complet test box 710. In example non-limiting embodiments, the interpolation for the primitive may be performed in the ray-primitive test box (RPT) 720.

In more detail, TTU 138 includes an intersection management block 722, a ray management block 730 and a stack management block 740. Each of these blocks (and all of the other blocks in FIG. 27) may constitute dedicated hardware implemented by logic gates, registers, hardware-embedded lookup tables or other combinatorial logic, etc.

The ray management block 730 is responsible for managing information about and performing operations concerning a ray specified by an SM 132 to the ray management block. The stack management block 740 works in conjunction with traversal logic 712 to manage information about and perform operations related to traversal of a BVH acceleration data structure. Traversal logic 712 is directed by results of a ray-complet test block 710 that tests intersections between the ray indicated by the ray management block 730 and volumetric subdivisions represented by the BVH, using instance transforms as needed. The ray-complet test block 710 retrieves additional information concerning the BVH from memory 140 via an L0 complet cache 752 that is part of the TTU 138. The results of the ray-complet test block 710 informs the traversal logic 712 as to whether further recursive traversals are needed. The stack management block 740 maintains stacks to keep track of state information as the traversal logic 712 traverses from one level of the BVH to another, with the stack management block 740 pushing items onto the stack as the traversal logic traverses deeper into the BVH and popping items from the stack as the traversal logic traverses upwards in the BVH. The stack management block 740 is able to provide state information (e.g., intermediate or final results) to the requesting SM 132 at any time the SM requests.

The intersection management block 722 manages information about and performs operations concerning intersections between rays and primitives, using instance transforms as needed. The ray-primitive test block 720 retrieves information concerning geometry from memory 140 on an as-needed basis via an L0 primitive cache 754 that is part of TTU 138. The intersection management block 722 is informed by results of intersection tests the ray-primitive test and transform block 720 performs. Thus, the ray-primitive test and transform block 720 provides intersection results to the intersection management block 722, which reports geometry hits and intersections to the requesting SM 132.

A Stack Management Unit 740 inspects the traversal state to determine what type of data needs to be retrieved and which data path (complet or primitive) will consume it. The intersections for the bounding volumes are determined in the ray-complet test path of the TTU 138 including one or more ray-complet test blocks 710 and one or more traversal logic blocks 712. A complet specifies root or interior nodes of a bounding volume. Thus, a complet may define one or more bounding volumes for the ray-complet test. In example embodiments herein, a complet may define a plurality of “child” bounding volumes that (whether or not they represent leaf nodes) that don't necessarily each have descendants but which the TTU will test in parallel for ray-bounding volume intersection to determine whether geometric primitives associated with the plurality of bounding volumes need to be tested for intersection.

The ray-complet test path of the TTU 138 identifies which bounding volumes are intersected by the ray. Bounding volumes intersected by the ray need to be further processed to determine if the primitives associated with the intersected bounding volumes are intersected. The intersections for the primitives are determined in the ray-primitive test path including one or more ray-primitive test and transform blocks 720 and one or more intersection management blocks 722.

The TTU 138 receives queries from one or more SMs 132 to perform tree traversal operations. The query may request whether a ray intersects bounding volumes and/or primitives in a BVH data structure. The query may identify a ray (e.g., origin, direction, and length of the ray) and a BVH data structure and traversal state (short stack) which includes one or more entries referencing nodes in one or more Bounding Volume Hierarchies that the ray is to visit. The query may also include information for how the ray is to handle specific types of intersections during traversal. The ray information may be stored in the ray management block 730. The stored ray information (e.g., ray length) may be updated based on the results of the ray-primitive test.

The TTU 138 may request the BVH data structure identified in the query to be retrieved from memory outside of the TTU 138. Retrieved portions of the BVH data structure may be cached in the level-zero (L0) cache 750 within the TTU 138 so the information is available for other time-coherent TTU operations, thereby reducing memory 140 accesses. Portions of the BVH data structure needed for the ray-complet test may be stored in a L0 complet cache 752 and portions of the BVH data structure needed for the ray-primitive test (e.g., LSS data blocks as discussed above) may be retrieved from system memory and stored in an L0 primitive cache 754.

After the complet information needed for a requested traversal step is available in the complet cache 752, the ray-complet test block 710 determines bounding volumes intersected by the ray. In performing this test, the ray may be transformed from the coordinate space of the bounding volume hierarchy to a coordinate space defined relative to a complet. The ray is tested against the bounding boxes associated with the child nodes of the complet. In the example non-limiting embodiment, the ray is not tested against the complet's own bounding box because (1) the TTU 138 previously tested the ray against a similar bounding box when it tested the parent bounding box child that referenced this complet, and (2) a purpose of the complet bounding box is to define a local coordinate system within which the child bounding boxes can be expressed in compressed form. If the ray intersects any of the child bounding boxes, the results are pushed to the traversal logic to determine the order that the corresponding child pointers will be pushed onto the traversal stack (further testing will likely require the traversal logic 712 to traverse down to the next level of the BVH). These steps are repeated recursively until intersected leaf nodes of the BVH are encountered.

The ray-complet test block 710 may provide ray-complet intersections to the traversal logic 712. Using the results of the ray-complet test, the traversal logic 712 creates stack entries to be pushed to the stack management block 740. The stack entries may indicate internal nodes (i.e., a node that includes one or more child nodes) that need to be further tested for ray intersections by the ray-complet test block 710 and/or primitives identified in an intersected leaf node that need to be tested for ray intersections by the ray-primitive test and transform block 720. The ray-complet test block 710 may repeat the traversal on internal nodes identified in the stack to determine all leaf nodes in the BVH that the ray intersects. The precise tests the ray-complet test block 710 performs will in the example non-limiting embodiment be determined by mode bits, ray operations (see below) and culling of hits, and the TTU 138 may return intermediate as well as final results to the SM 132.

### Ray-Primitive Intersection Testing

Referring again to FIG. 27, the TTU 138 also has the ability to accelerate intersection tests that determine whether a ray intersects particular geometry or primitives. For some cases, the geometry is sufficiently complex (e.g., certain kinds of procedural geometry such as swept spheres connected by cubic splines) that TTU 138 in some embodiments may not be able to help with the ray-primitive intersection testing. In such cases, the TTU 138 simply reports the ray-complet intersection test results to the SM 132, and the SM 132 performs the ray-primitive intersection test itself. In other cases (e.g., triangle primitives and linear swept sphere primitives), the TTU 138 can perform the ray-primitive intersection test itself in its own hardware circuitry, thereby further increasing performance of the overall ray tracing process. The following describes how the TTU 138 can perform or accelerate the ray-primitive intersection testing.

As explained above, leaf nodes found to be intersected by the ray identify (enclose) primitives that may or may not be intersected by the ray. One option is for the TTU 138 to provide e.g., a range of geometry identified in the intersected leaf nodes to the SM 132 for further processing. For example, the SM 132 may itself determine whether the identified primitives are intersected by the ray based on the information the TTU 138 provides as a result of the TTU traversing the BVH. To offload this processing from the SM 132 and thereby accelerate it using the hardware of the TTU 138, the stack management block 740 may issue requests for the ray-primitive and transform block 720 to perform a ray-primitive test for the primitives within intersected leaf nodes the TTU's ray-complet test block 710 identified. In some embodiments, the SM 132 may issue a request for the ray-primitive test to test a specific range of primitives and transform block 720 irrespective of how that geometry range was identified.

After making sure the primitive data needed for a requested ray-primitive test is available in the primitive cache 754, the ray-primitive and transform block 720 may determine primitives that are intersected by the ray using the ray information stored in the ray management block 730. The ray-primitive test block 720 provides the identification of primitives determined to be intersected by the ray to the intersection management block 722.

The intersection management block 722 can return the results of the ray-primitive test to the SM 132. As noted above, the results of the ray-primitive test may include identifiers of intersected primitives, the distance of intersections from the ray origin and other information concerning properties of the intersected primitives. In some embodiments, the intersection management block 722 may modify an existing ray-primitive test (e.g., by modifying the length of the ray) based on previous intersection results from the ray-primitive and transform block 720.

The intersection management block 722 may also keep track of different types of primitives. For example, the different types of LSS primitives include opaque primitives that will block a ray when intersected and alpha primitives that may or may not block the ray when intersected or may require additional handling by the SM. Whether a ray is blocked or not by a transparent primitive may for example depend on a variety of factors. For example, transparency in some embodiments requires the SM 132 to keep track of transparent object hits so they can be sorted and shaded in ray-parametric order, and typically don't actually block the ray. (Note that in raster graphics, transparency is often called “alpha blending” and trimming is called “alpha test”). In other embodiments, the TTU 138 can push transparent hits to queues in memory for later handling by the SM 132. The intersection management block 722 is configured to maintain a result queue for tracking the different types of intersected primitives. For example, the result queue may store one or more intersected opaque LSS primitive identifiers in one queue and one or more transparent LSS primitive identifiers in another queue.

For transparent primitive, ray intersections cannot in some embodiments be fully determined in the TTU 138 because TTU 138 performs the intersection test based on the geometry of the primitive and may not have access to texture, shading and other information. To fully determine whether the primitive is intersected, information about transparent primitives the ray-primitive and transform block 720 determines are intersected may be sent to the SM 132, for the SM to make the full determination as to whether the transparent primitive affects visibility along the ray.

The SM 132 can resolve whether or not the ray intersects a transparent primitive and/or whether the ray will be blocked by the primitive. The SM 132 may in some cases send a modified query to the TTU 138 (e.g., shortening the ray if the ray is blocked by the primitive) based on this determination. In one embodiment, the TTU 138 may be configured to return all primitives determined to intersect the ray to the SM 132 for further processing. Because returning every primitive intersection to the SM 132 for further processing is costly in terms of interface and thread synchronization, the TTU 138 may be configured to hide primitives which are intersected but are provably capable of being hidden without a functional impact on the resulting scene. For example, because the TTU 138 is provided with primitive type information (e.g., whether a primitive is opaque or transparent), the TTU 138 may use the primitive type information to determine intersected primitives that are occluded along the ray by another intersecting opaque primitive and which thus need not be included in the results because they will not affect the visibility along the ray. If the TTU 138 knows that a primitive is occluded along the ray by an opaque primitive, the occluded primitive can be hidden from the results without impact on visualization of the resulting scene.

The intersection management block 722 may include a result queue for storing hits that associate a primitive ID and information about the point where the ray hit the primitive. When a ray is determined to intersect an opaque primitive, the identity of the primitive and the distance of the intersection from the ray origin can be stored in the result queue. If the ray is determined to intersect another opaque primitive, the other intersected opaque primitive can be omitted from the result if the distance of the intersection from the ray origin is greater than the distance of the intersected opaque primitive already stored in the result queue. If the distance of the intersection from the ray origin is less than the distance of the intersected opaque primitive already stored in the result queue, the other intersected opaque primitive can replace the opaque primitive stored in the result queue. After all of the primitives of a query have been tested, the opaque primitive information stored in the result queue and the intersection information may be sent to the SM 132.

In some embodiments, once an opaque primitive intersection is identified, the intersection management block 722 may shorten the ray stored in the ray management block 730 so that bounding volumes behind the intersected opaque primitive (along the ray) will not be identified as intersecting the ray.

The intersection management block 722 may store information about intersected transparent primitives in a separate queue. The stored information about intersected transparent primitives may be sent to the SM 132 for the SM to resolve visualization issues beyond the current capability of the TTU hardware. The SM may return the results of this determination to the TTU 138 and/or modify the query (e.g., shorten the ray if the ray) based on this determination.

As discussed above, the TTU 138 allows for quick traversal of an acceleration data structure (e.g., a BVH) to determine which primitives in the data structure are intersected by a query data structure (e.g., a ray). For example, the TTU 138 may determine which primitives in the acceleration data structure are intersected by the ray and return the results to the SM 132. However, returning to the SM 132 a result on every primitive intersection is costly in terms of interface and thread synchronization. The TTU 138 provides a hardware logic configured to hide those primitives which are provably capable of being hidden without a functional impact on the resulting scene. The reduction in returns of results to the SM and synchronization steps between threads greatly improves the overall performance of traversal. The example non-limiting embodiments of the TTU 138 disclosed in this application provides for some of the intersections to be discarded within the TTU 138 without SM 132 intervention so that less intersections are returned to the SM 132 and the SM 132 does not have to inspect all intersected primitives or item ranges.

All patents and publications cited herein are incorporated by reference as if expressly set forth.

While the invention has been described in connection with what is presently considered to be the most practical and preferred embodiments, it is to be understood that the invention is not to be limited to the disclosed embodiments. For example, while example embodiments use linear curves to reduce hardware complexity, as hardware complexity continues to increase it may become feasible to implement intersectors that operate on quadratic or cubic curve-connected swept spheres. Accordingly, embodiments described herein that describe features orthogonal to or independent of linear curves should not be limited to linear or 2-degree curves but may also encompass higher order curves. Similarly, while example embodiments use swept spheres, other applications may sweep shapes other than spheres. On the contrary, this patent is intended to cover various modifications and equivalent arrangements included within the spirit and scope of the appended claims.

1. A hardware-based ray tracer comprising:
a multi-pass ray-primitive intersector circuit configured to receive first data indicating a ray and second data representing a linear swept sphere primitive, the ray-primitive intersector circuit determining intersection between the ray and the linear swept sphere primitive,
wherein the multi-pass ray-primitive intersector circuit includes a loopback connection that the multi-pass ray-primitive intersector circuit with a variable number of passes depending on at least one characteristic of the second data.

2. The hardware-based ray tracer of claim 1 wherein at least one characteristic comprises whether the second data represents a degenerate or a non-degenerate linear swept sphere primitive.

3. The hardware-based ray tracer of claim 1 wherein the multi-pass ray-primitive intersector circuit comprises an intersector pipeline and a distance calculator pipeline each comprising at least one hardware adder circuit, at least one hardware multiplier circuit and at least one hardware comparator circuit.

4. The hardware-based ray tracer of claim 1 wherein the linear swept sphere primitive includes first and second endcaps, and the second data includes a first field that enables the first endcap and a second field that enables the second endcap, wherein the first and second endcaps can be independently enabled and disabled.

5. The hardware-based ray tracer of claim 1 wherein the linear swept sphere primitive can selectively be opaque or transparent.

6. The hardware-based ray tracer of claim 1 wherein the linear swept sphere primitive includes first and second spheres each having a specifiable center point and a specifiable radius, and further includes a linear connector between the first and second spheres, wherein the linear connector intersects each of the first and second spheres tangentially to the respective sphere.

7. The hardware-based ray tracer of claim 6 wherein the multi-pass ray-primitive intersector circuit is configured to calculate and report a distance parameter u along the linear connector where the ray intersects the primitive.

8. The hardware-based ray tracer of claim 6 wherein the multi-pass ray-primitive intersector circuit is configured to determine whether the ray intersects the first sphere or the second sphere without intersecting the linear connector between the first sphere and the second sphere.

9. The hardware-based ray tracer of claim 1 wherein the multi-pass ray-primitive intersector circuit is configured to determine intersection between the ray and the linear swept sphere primitive without referring the intersection determining to any processor executing a software shader.

10. A non-transitory memory connected to a hardware-based ray tracer, the non-transitory memory storing acceleration data blocks comprising data representing linear swept sphere primitives, wherein the data includes mode indicators that indicate:
Explicit Vertex Indexing wherein a VertexIDs array specifies explicit vertex indices for every primitive (i.v0, i.v1);
Chains with Shared Implicit Indexing wherein Vertex indices are applied sequentially and an i.chainStart bit vector specifies which vertices are shared between neighboring primitives;
Unconnected Unshared Implicit Indexing wherein two vertex indices are applied sequentially per primitive; and
Spheres with Unshared Implicit Indexing wherein a single vertex index is applied sequentially per primitive, with both the v0 and v1 indices pointing to that same vertex.

11. A ray tracer intersector circuit comprising:
an intersection pipelined circuit configured to receive linear swept sphere primitive data and ray original and direction data, and is further configured to test whether a conical surface represented by the linear swept sphere primitive data intersects a ray; and
a distance pipelined circuit connected to the intersection pipelined circuit, the intersection pipelined circuit configured to output intersection coordinate values indicating where the ray intersects the conical surface,
wherein the intersection pipelined circuit is further configured to test whether an interpolation of the conical surface exists at an instant of the ray.

12. An acceleration data structure builder comprising:
at least one processor or processing circuit configured to execute instructions stored in non-transitory memory to perform operations comprising:
providing to an output file, delta compressed vertices of spheres defining center points and radii of a multiplicity of linear swept sphere primitives; and
specifying to the output file, an indexing mode from a set consisting of Explicit Vertex Indexing, Chains with Shared Implicit Indexing, Unconnected LSS: Unshared Implicit Indexing, and Spheres: with Unshared Implicit Indexing.

13. The acceleration data structure builder of claim 12 wherein the acceleration data structure builder further specifies to the output file, whether the linear swept sphere primitives are to be interpolated to detect whether they exist at an instant of a ray.

14. The acceleration data structure builder of claim 12 wherein the acceleration data structure builder further specifies to the output file, a number 1-N of primitives.

15. The acceleration data structure builder of claim 12 wherein the acceleration data structure builder further specifies to the output file, whether the linear swept sphere primitives are transparent.

16. The acceleration data structure builder of claim 12 wherein the acceleration data structure builder further specifies to the output file, an identifier for each primitive.

17. The acceleration data structure builder of claim 12 wherein the acceleration data structure builder further specifies to the output file, a variable precision of vertex center points and a variable precision of the radii.

18. The acceleration data structure builder of claim 12 wherein the acceleration data structure builder further specifies to the output file, an LSS header that specifies to hardware that the output file contains linear swept sphere primitives.

19. The acceleration data structure builder of claim 12 wherein the acceleration data structure builder further specifies to the output file, whether the linear swept sphere primitives have constant alpha values across the output file.

20. A non-transitory memory coupled to a hardware decoder and intersector circuit, the non-transitory memory storing a data file comprising:
delta compressed vertices of spheres defining center points and radii of a multiplicity of linear swept sphere primitives;
an indexing mode indicator selected from a set consisting of Explicit Vertex Indexing, Chains with Shared Implicit Indexing, Unconnected LSS with Unshared Implicit Indexing, and Spheres with Unshared Implicit Indexing;
an indicator of whether the linear swept sphere primitives are to be interpolated to detect whether they exist at an instant of a ray;
a value indicating a number 1-N of primitives;
an indicator indicating whether the primitives are transparent;
an identifier for each primitive;
a variable precision for vertex center points and a variable precision for radii;
an LSS header that specifies to the hardware decoder that an output file contains linear swept sphere primitives; and
an indicator of whether the linear swept sphere primitives have constant alpha values across the data file.
